(19) United States
(12) Patent Application Publication
(10) Pub. No.: US 2026/0060244 A1
(43) Pub. Date: Mar. 5, 2026

(54) WATER-BASED PEST CONTROL COMPOSITIONS

(71) Applicant: S. C. JOHNSON & SON, INC., Racine, WI (US)

(72) Inventor: Christina Rozeske, Racine, WI (US)

(21) Appl. No.: 19/310,451

(22) Filed: Aug. 26, 2025

Related U.S. Application Data
(60) Provisional application No. 63/688,161, filed on Aug. 28, 2024.

(51) Int. Cl. A01N 25/30; A01N 31/02; A01N 37/02; A01N 65/06; A01N 65/08; A01N 65/22; A01N 65/24; A01N 65/28; A01N 65/42; A01N 65/44; A01P 7/04

(52) U.S. Cl. CPC A01N 25/30; A01N 31/02; A01N 37/02; A01N 65/06; A01N 65/08; A01N 65/22; A01N 65/24; A01N 65/28; A01N 65/42; A01N 65/44; A01P 7/04

(57) ABSTRACT

A pest control composition is disclosed herein. The composition may comprise an active ingredient, a surfactant, a salt, a solvent, and water. In some embodiments, the composition disclosed herein may remain stable over a wide range of temperatures. Related methods of use and manufacture are also disclosed.

### CROSS REFERENCE TO RELATED APPLICATIONS

This application is related to, claims priority to, and incorporates herein by reference for all purposes U.S. Provisional Patent Application No. 63/688,161, filed Aug. 28, 2024.

### REFERENCE REGARDING FEDERALLY SPONSORED RESEARCH OR DEVELOPMENT

Not applicable.

### SEQUENCE LISTING

Not applicable.

### BACKGROUND

### 1. Technology Field

The present disclosure relates to a pest control composition, and more particularly to a water-based pest control composition, including a surfactant containing a soap.

### 2. Description of the Background

Pest control compositions, including insecticide and insect repellent compositions have been used over the years to prevent insects from attacking humans, animals, crops, and food. One disadvantage of many insecticides and insect repellent compositions currently available is their unpleasant, harsh, and lingering chemical odor. In providing insecticide and insect repellent compositions with a more pleasant and less harsh odor, pest killing/repelling efficacies and/or time to achieve pest mortality are compromised due to the necessity to employ fewer, or reduced concentrations of, chemical active ingredients and inert ingredients.

In addition, many of the insecticide and insect repellent compositions in the market contain palm oil-derived surfactants. Palm deforestation raises concerns regarding environmental health and sustainability, which encourages the development and consumption of products with alternative formulations. Furthermore, many oil-based and/or biphasic pest control compositions currently on the market are unsatisfactory, due to the need of thorough mixing before using and the difficulty in cleaning up.

Therefore, there remains a need for alternative pest control compositions that are easy to apply, stable, and reduces harsh and lingering chemical odor, without damaging the environment or sacrificing efficacy in killing and/or repelling insects.

### SUMMARY

Embodiments of the current disclosure describe a pest control composition, for example, a water-based pest control composition comprising a surfactant, such as a soap.

One aspect of the current disclosure provides a pest control composition. The composition may comprise from about 0.25 wt. % to about 10 wt. % of an active ingredient comprising one or more essential oils, from about 10 wt. % to about 30 wt. % of a surfactant comprising potassium cocoate; from about 5 wt. % to about 30 wt. % of a solvent; from about 0.005 wt. % to about 0.1 wt. % of a salt; and from about 40 wt. % to about 70 wt. % of water. All weight percentages are percent by weight of the total composition. In certain embodiments, the composition is single-phased between about 0° C. to about 54° C.

Another aspect of the current disclosure provides a pest control composition. The composition may comprise from about 1 wt. % to about 10 wt. % of an active ingredient comprising one or more essential oils; from about 10 wt. % to about 30 wt. % of a surfactant comprising a mixture of potassium salts of C6-C20 fatty acids; from about 5 wt. % to about 30 wt. % of a solvent; from about 0.005 wt. % to about 0.1 wt. % of a salt; and from about 40 wt. % to about 70 wt. % of water. All weight percentages are percent by weight of the total composition. In certain embodiments, the composition is single-phased between about 0° C. to about 54° C.

In certain embodiments, the C6-C20 fatty acids comprises caproic acid, caprylic acid, capric acid, lauric acid, myristic acid, palmitic acid, stearic acid, arachidic acid, oleic acid, linoleic acid, or any combinations thereof. In certain embodiments, at least 40 wt. % of the C6-C20 fatty acids is a saturated C12 fatty acid.

In certain embodiments, the essential oil is selected from 2-phenylethyl propionate, cedarwood oil, geraniol, cinnamon oil, citronella oil, clove oil, eugenol, garlic oil, geranium oil, spearmint oil, peppermint oil, cornmint oil, lemongrass oil, rosemary oil, thyme oil, wintergreen oil, and mixtures thereof. In certain embodiments, the essential oil is 2-phenylethyl propionate. In certain embodiments, the solvent comprises isopropyl alcohol. In certain embodiments, the salt comprises sodium chloride.

In certain embodiments, the total amount of the surfactant and the total amount of the essential oil have a weight ratio of at least 3:1. In certain embodiments, the solvent is at least 15 wt. % of the total composition. In certain embodiments, the composition is clear and colorless between about 0° C. to about 54° C.

Another aspect of the current disclosure provides a pest control composition. The composition may comprise from about 0.25 wt. % to about 10 wt. % of an essential oil selected from 2-phenylethyl propionate, cedarwood oil, geraniol, cinnamon oil, citronella oil, clove oil, eugenol, garlic oil, geranium oil, spearmint oil, peppermint oil, cornmint oil, lemongrass oil, rosemary oil, thyme oil, wintergreen oil, and mixtures thereof; from about 1 wt. % to about 30 wt. % of potassium cocoate; from about 5 wt. % to about 30 wt. % of isopropyl alcohol; from about 0.005 wt. % to about 0.1 wt. % of sodium chloride; and from about 40 wt. % to about 95 wt. % of water. All weight percentages are percent by weight of the total composition. In certain embodiments, the total amount of potassium cocoate and the total amount of the essential oil have a weight ratio of at least 3:1. In certain embodiments, the composition is single-phased, clear, and colorless between about 0° C. to about 54° C.

Another aspect of the current disclosure provides a pest control composition. The composition may comprise from about 0.25 wt. % to about 10 wt. % of an active ingredient comprising one or more essential oils; from about 1 wt. % to about 30 wt. % of a surfactant comprising potassium cocoate; from about 5 wt. % to about 30 wt. % of a solvent; from about 0.005 wt. % to about 0.1 wt. % of a salt; and from about 40 wt. % to about 95 wt. % of water. All weight percentages are percent by weight of the total composition. In certain embodiments, the composition is single-phased between about 0° C. to about 54° C.

Another aspect of the current disclosure provides a pest control composition. The composition may comprise an active ingredient comprising one or more essential oils; a surfactant comprising sodium ricinoleate; a solvent; from about 0.02 wt. % to about 0.1 wt. % of a salt; and water. All weight percentages are percent by weight of the total composition.

In certain embodiments, the essential oil is selected from 2-phenylethyl propionate, cedarwood oil, geraniol, cinnamon oil, citronella oil, clove oil, eugenol, garlic oil, geranium oil, spearmint oil, peppermint oil, cornmint oil, lemongrass oil, rosemary oil, thyme oil, wintergreen oil, and mixtures thereof. In certain embodiments, the essential oil is 2-phenylethyl propionate.

In certain embodiments, the active ingredient is from about 0.1 wt. % to about 5 wt. % of the total composition. In certain embodiments, the surfactant is from about 0.5 wt. % to about 50 wt. % of the total composition. In certain embodiments, the salt comprises sodium chloride. In certain embodiments, the solvent comprises isopropyl alcohol. In certain embodiments, the solvent is from about 1 wt. % to about 20 wt. % of the total composition. In certain embodiments, the solvent is at least 10 wt. % of the total composition. In certain embodiments, the total amount of the surfactant and the total amount of the essential oil have a weight ratio of at least 3:1. In certain embodiments, the composition is clear, colorless, and single-phased between about 0° C. to about 54° C.

Another aspect of the current disclosure provides a pest control composition. The composition may comprise an active ingredient consisting essentially of 2-phenylethyl proprionate; a surfactant consisting essentially of sodium ricinoleate; a solvent consisting essentially of isopropyl alcohol; from about 0.02 wt. % to about 0.1 wt. % of a salt; and water. All weight percentages are percent by weight of the total composition.

In certain embodiments, the salt comprises sodium chloride. In certain embodiments, the active ingredient is from about 0.1 wt. % to about 5 wt. % of the total composition. In certain embodiments, the surfactant is from about 0.5 wt. % to about 50 wt. % of the total composition. In certain embodiments, the solvent is from about 1 wt. % to about 20 wt. % of the total composition. In certain embodiments, the solvent is at least 10 wt. % of the total composition. In certain embodiments, the total amount of the surfactant and the total amount of the essential oil have a weight ratio of at least 3:1.

Another aspect of the current disclosure provides a pest control composition. The composition may comprise from about 0.1 wt. % to about 5 wt. % of an active ingredient comprising one or more essential oils; from about 0.5 wt. % to about 50 wt. % of sodium ricinoleate; from about 1 wt. % to about 20 wt. % of isopropyl alcohol; from about 0.02 wt. % to about 0.1 wt. % of sodium chloride; and water. All weight percentages are percent by weight of the total composition.

### DETAILED DESCRIPTION

The term “about” or “approx.”, as used herein, refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values +/−5% of a specified value.

The term “weight percent”, “wt. %”, “wt. %,” “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only refers to insects, but may also to mites, spiders, and other arachnids, larvae, and like invertebrates. Further, for purposes of this application, the term “pest control” shall refer to having a repellent effect, a pesticidal effect, or both. “Repellent effect” is an effect wherein more insects are repelled away from a host or area that has been treated with the composition than a control host or area that has not been treated with the composition. Similarly, the term “repelling” or “repel” refers to the ability of the compositions described herein to cause a pest or insect to deviate away from or avoid a surface, object or insect breeding site treated with said composition. In some embodiments, as will be shown in the present disclosure, a repellent effect is an effect wherein at least about 75% of insects are repelled away from a host or area that has been treated with the composition. In addition, “pesticidal effect” or “insecticidal effect” is an effect wherein treatment with a composition causes at least about 1% of the insects to die. In this regard, an LC1 to LC100 (lethal concentration) or an LD1 to LD100 (lethal dose) of a composition will cause a pesticidal effect. In some embodiments, the pesticidal effect or the insecticidal effect is an effect wherein treatment with a composition causes at least about 5% of the exposed insects to die. In some embodiments, the target pest is a non-insect, such as a parasite.

As used herein, the term “killing” or “kill” refers to the ability of at least one active ingredient in a composition to render an insect dead. As further used herein, the term “knocking down” or “knockdown” refers to the ability of the composition described herein to render an insect immobile for a pre-determined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

Embodiments of the invention can be used to control parasites. The term “parasite” encompasses numerous protozoa, helminths, and ectoparasites. Protozoa may include the ameba, flagellates, ciliates, and the sporozoa. Protozoa typically infect the blood and tissue and may be transmitted through the bite of a mosquito. Protozoa are responsible for such diseases as malaria, trypanosomiasis, leishmaniasis, toxoplasmosis, and cryptosporidiosis. Helminths are typically classified into three groups, flatworms, roundworms, and thorny-headed worms. Helminths are responsible for such diseases as enterobiasis, ascariasis, taeniasis, cysticercosis, and schistosomiasis. Ectoparasites may include mosquitoes, ticks, fleas, lice, and mites. Many ectoparasites may cause disease on their own, but are even more important as vectors of a number of different pathogens, including protozoa.

In the pest control field, it is known that consumers desire stable, user-friendly, and environmental-friendly products without sacrificing efficacy. It has been found that a pest control composition, such as an insecticidal composition and an insect repellent composition that includes a soap, such as potassium cocoate or sodium ricinoleate, provides such benefits.

The pest control composition according to an embodiment of the present disclosure may comprise a water-based pest control composition. The composition may comprise an active ingredient, a surfactant, a solvent, a salt, and water.

In certain embodiments, the composition described herein can achieve a clear, colorless, and single-phased water-based solution while remaining stable and single-phased across a wide range of temperature conditions, such as during one or more freeze/thaw cycles. The single phase, clear, and colorless composition is also desirable to consumers because it would look appealing in transparent packaging. In certain embodiments, the composition may remain stable on the shelf or throughout the supply chain without compromised performances for at least 2 years over a range of usage temperatures. For example, the composition may remain clear, colorless, and single-phased on the shelf or throughout the supply chain without compromised performances for at least 2 years between about 0° C. to about 25° C., or between about 0° C. to about 54° C.

Another advantage of the composition described herein is its case of use. Consumers do not need to shake the product prior to using due to the stable and single-phased solution. Furthermore, a clear, water-based product is desirable for consumers because it does not leave behind greasy residues and is easier to be cleaned, comparing to alternative oil-based compositions. Many of these oil-based products often instruct the consumers to clean the product up with soap and water. Therefore, having a water-based formula would eliminate this extra cleanup step.

Another advantage of the composition described herein is its environmentally friendly formula without the use of any palm-oil derived ingredients, therefore reducing palm deforestation and contributing to the sustainability commitments.

As used herein, “stable” refers to the composition's ability to remain single-phased, clear, and colorless after thawing to ambient temperature, and/or at a temperature range of 40-90° F. For example, an “unstable solution” may refer to a solution that is slightly hazy or milky, exhibits separation of the oil and aqueous components, or is not water-white, as assessed through visual inspection.

As used herein, “clear” refers to a transparent state of a solution, in which all the substances remain dissolved and disappeared when evaluated visually by human eyes. Therefore, no haziness or milkiness is observed.

In certain embodiments, the pest control compositions described herein are prepared by adding the ingredients to a scintillation vial and adding the remaining amount of water to add up to 100%, shaking the vial to mix after each addition. The appearance of the solution is determined through visual observation. The compositions that are clear and colorless after mixing are then placed in a freezer overnight and allowed to thaw. Formulas that remained single phase, clear, and colorless after thawing to ambient temperature are considered stable.

Surfactant. The pest control composition disclosed herein may include a surfactant. The basic way in which surfactants act is determined by their structure. With a hydrophilic head and hydrophobic tail, surfactant molecules become interposed between water and water-insoluble substances such as oil, dirt and grease, collectively referred to as “soil particles.” By enriching themselves at the boundaries which water forms with air or oil, surfactants lower the surface tension of the water. When dissolved in water at higher concentrations, surfactant molecules group themselves together to form spherical structures around soil particles referred to as micelles. The inwardly directed hydrophobic groups surround soil particles and keep the otherwise insoluble soil particles in solution.

The total amount of the surfactant in the pest control composition may be from about 0.1 wt. % to about 30 wt. %; from about 0.1 wt. % to about 20 wt. %; from about 0.1 wt. % to about 10 wt. %; from about 0.1 wt. % to about 5 wt. %; from about 0.1 wt. % to about 4 wt. %; from about 0.1 wt. % to about 3 wt. %; from about 0.1 wt. % to about 2 wt. %; from about 0.1 wt. % to about 1.5 wt. %; from about 0.1 wt. % to about 1 wt. %; or from about 0.1 wt. % to about 0.5 wt. %. In certain embodiments, the total amount of the surfactant in the pest control composition may be about 20 wt. %. In certain embodiments, the total amount of the surfactant in the pest control composition may be about 5 wt. %. In certain embodiments, the total amount of the surfactant in the pest control composition may be about 1 wt. %.

In certain embodiments, the surfactant comprises an anionic surfactant, such as a soap. Soaps may be prepared through reactions between a base and an acid or an ester, such as through a saponification reaction. Suitable bases include, but are not limited to, metallic alkali bases such as potassium hydroxide, sodium hydroxide, and lithium hydroxide. Commonly used acids and esters include fats and oils, such as coconut oil, avocado oil, castor oil, olive oil, palm oil, tallow, and others. In certain embodiments, the soap molecule helps solubilize the active ingredient (e.g., essential oil) in the formula, which allows the active ingredient to be more effective on the target (e.g., pest).

In certain embodiments, the surfactant comprises sodium ricinoleate, which may be prepared from reactions between ricinoleic fatty acid and sodium hydroxide. Ricinoleic fatty acid is derived from castor oil. Commercially available examples of sodium ricinoleate include Innoleate RA-Na.

In certain embodiments, the pest control composition includes a total amount of from about 0.5 wt. % to about 60 wt. % of sodium ricinoleate. In certain embodiments, the pest control composition includes a total amount of from about 0.5 wt. % to about 50 wt. % of sodium ricinoleate. In certain embodiments, the pest control composition includes a total amount of from about 0.5 wt. % to about 40 wt. % of sodium ricinoleate. In certain embodiments, the pest control composition includes a total amount of from about 0.5 wt. % to about 30 wt. % of sodium ricinoleate. In certain embodiments, the pest control composition includes a total amount of from about 0.5 wt. % to about 20 wt. % of sodium ricinoleate. In certain embodiments, the pest control composition includes a total amount of from about 0.5 wt. % to about 10 wt. % of sodium ricinoleate. In certain embodiments, the pest control composition includes a total amount of from about 0.5 wt. % to about 5 wt. % of sodium ricinoleate. In certain embodiments, the pest control composition includes a total amount of from about 0.5 wt. % to about 1 wt. % of sodium ricinoleate. In certain embodiments, the pest control composition includes a total amount of from about 1 wt. % to about 60 wt. % of sodium ricinoleate. In certain embodiments, the pest control composition includes a total amount of from about 1 wt. % to about 50 wt. % of sodium ricinoleate. In certain embodiments, the pest control composition includes a total amount of from about 1 wt. % to about 40 wt. % of sodium ricinoleate. In certain embodiments, the pest control composition includes a total amount of from about 1 wt. % to about 30 wt. % of sodium ricinoleate. In certain embodiments, the pest control composition includes a total amount of from about 1 wt. % to about 20 wt. % of sodium ricinoleate. In certain embodiments, the pest control composition includes a total amount of from about 1 wt. % to about 15 wt. % of sodium ricinoleate. In certain embodiments, the pest control composition includes a total amount of from about 1 wt. % to about 10 wt. % of sodium ricinoleate. In certain embodiments, the pest control composition includes a total amount of about 5 wt. % of sodium ricinoleate.

In certain embodiments, the surfactant consists essentially of sodium ricinoleate. In certain embodiments, the surfactant consists of sodium ricinoleate. In certain embodiments, the surfactant and the pest control composition are free of sodium lauryl sulfate (SLS), sodium dodecyl sulfate (SDS), or a combination thereof.

In certain embodiments, the surfactant includes potassium cocoate, which may be prepared from reactions between coconut oil and potassium hydroxide. Coconut oil is made up of a wide range of saturated and unsaturated fatty acids, see Table 1. The majority, e.g., 45-50%, of the fatty acids in coconut oil are fatty acids containing 12 carbons. Accordingly, potassium cocoate is made up of a wide range of potassium soaps derived from the corresponding fatty acids, including Potassium Caproate, Potassium Caprylate, Potassium Caprate, Potassium Laurate, Potassium Myristate, Potassium Palmitate, Potassium Stearate, Potassium Arachidate, Potassium Oleate, and Potassium Linoleate, see Table 1. Commercially available examples of potassium cocoate include Cola®Det KC-40 and Potassium Cocoate 40 from Sanitek.

TABLE 1
Fatty acid components of coconut oil and
their corresponding potassium soaps.

| | Carbons:Un- | | |
|---|---|---|---|
| Fatty Acid | saturation | Percentage | Potassium Soap |
| Caproic Acid | 6:00 | 0.2-0.5 | Potassium Caproate |
| Caprylic Acid | 8:00 | 5.4-9.5 | Potassium Caprylate |
| Capric Acid | 10:00 | 4.5-9.7 | Potassium Caprate |
| Lauric Acid | 12:00 | 44.1-51 | Potassium Laurate |
| Myristic Acid | 14:00 | 13.1-18.5 | Potassium Myristate |
| Palmitic Acid | 16:00 | 7.5-10.5 | Potassium Palmitate |
| Stearic Acid | 18:00 | 1.0-3.2 | Potassium Stearate |
| Arachidic Acid | 20:00 | 0.2-1.5 | Potassium Arachidate |
| Oleic Acid | 18:1n-9 | 5.0-8.2 | Potassium Oleate |
| Linoleic Acid | 18:2n-6 | 1.0-2.6 | Potassium Linoleate |

In certain embodiments, the pest control composition includes a total amount (i.e., the total amount of all the components of potassium cocoate) of from about 0.1 wt. % to about 30 wt. % of potassium cocoate. In certain embodiments, the pest control composition includes a total amount of from about 0.1 wt. % to about 20 wt. % of potassium cocoate. In certain embodiments, the pest control composition includes a total amount of from about 0.1 wt. % to about 10 wt. % of potassium cocoate. In certain embodiments, the pest control composition includes a total amount of from about 0.1 wt. % to about 5 wt. % of potassium cocoate. In certain embodiments, the pest control composition includes a total amount of from about 0.1 wt. % to about 4 wt. % of potassium cocoate. In certain embodiments, the pest control composition includes a total amount of from about 0.1 wt. % to about 3 wt. % of potassium cocoate. In certain embodiments, the pest control composition includes a total amount of from about 0.1 wt. % to about 2 wt. % of potassium cocoate. In certain embodiments, the pest control composition includes a total amount of from about 0.1 wt. % to about 1.5 wt. % of potassium cocoate. In certain embodiments, the pest control composition includes a total amount of from about 0.1 wt. % to about 1 wt. % of potassium cocoate. In certain embodiments, the pest control composition includes a total amount of from about 0.1 wt. % to about 0.5 wt. % of potassium cocoate. In certain embodiments, the pest control composition includes a total amount of about 20 wt. % of potassium cocoate. In certain embodiments, the pest control composition includes a total amount of about 1 wt. % of potassium cocoate.

In certain embodiments, the total amount of potassium caproate in the pest control composition may be from about 0.001 wt. % to about 0.3 wt. %, from about 0.001 wt. % to about 0.2 wt. %, from about 0.001 wt. % to about 0.1 wt. %, or from about 0.001 wt. % to about 0.005 wt. %.

In certain embodiments, the total amount of potassium caprylate in the pest control composition may be from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.01 wt. % to about 0.1 wt. %, or from about 0.01 wt. % to about 0.05 wt. %.

In certain embodiments, the total amount of potassium caprate in the pest control composition may be from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.01 wt. % to about 0.1 wt. %, or from about 0.01 wt. % to about 0.05 wt. %.

In certain embodiments, the total amount of potassium laurate in the pest control composition may be from about 0.1 wt. % to about 20 wt. %, from about 0.1 wt. % to about 15 wt. %, from about 0.1 wt. % to about 10 wt. %, from about 0.1 wt. % to about 5 wt. %, from about 0.1 wt. % to about 1 wt. %, from about 0.1 wt. % to about 0.8 wt. %, or from about 0.1 wt. % to about 0.4 wt. %.

In certain embodiments, the total amount of potassium myristate in the pest control composition may be from about 0.01 wt. % to about 8 wt. %, from about 0.01 wt. % to about 5 wt. %, from about 0.01 wt. % to about 2 wt. %, from about 0.01 wt. % to about 1 wt. %, from about 0.01 wt. % to about 0.5 wt. %, from about 0.01 wt. % to about 0.3 wt. %, or from about 0.01 wt. % to about 0.2 wt. %.

In certain embodiments, the total amount of potassium palmitate in the pest control composition may be from about 0.01 wt. % to about 8 wt. %, from about 0.01 wt. % to about 5 wt. %, from about 0.01 wt. % to about 2 wt. %, from about 0.01 wt. % to about 1 wt. %, from about 0.01 wt. % to about 0.5 wt. %, from about 0.01 wt. % to about 0.3 wt. %, or from about 0.01 wt. % to about 0.2 wt. %.

In certain embodiments, the total amount of potassium stearate in the pest control composition may be from about 0.01 wt. % to about 2 wt. %, from about 0.01 wt. % to about 1 wt. %, from about 0.01 wt. % to about 0.5 wt. %, from about 0.01 wt. % to about 0.1 wt. %, or from about 0.01 wt. % to about 0.05 wt. %.

In certain embodiments, the total amount of potassium arachidate in the pest control composition may be from about 0.01 wt. % to about 2 wt. %, from about 0.01 wt. % to about 1 wt. %, from about 0.01 wt. % to about 0.5 wt. %, from about 0.01 wt. % to about 0.1 wt. %, or from about 0.01 wt. % to about 0.05 wt. %.

In certain embodiments, the total amount of potassium oleate in the pest control composition may be from about 0.01 wt. % to about 5 wt. %, from about 0.01 wt. % to about 4 wt. %, from about 0.01 wt. % to about 3 wt. %, from about 0.01 wt. % to about 2 wt. %, from about 0.01 wt. % to about 1 wt. %, from about 0.01 wt. % to about 0.5 wt. %, from about 0.01 wt. % to about 0.25 wt. %, or from about 0.01 wt. % to about 0.1 wt.

In certain embodiments, the total amount of potassium linoleate in the pest control composition may be from about 0.01 wt. % to about 2 wt. %, from about 0.01 wt. % to about 1 wt. %, from about 0.01 wt. % to about 0.5 wt. %, from about 0.01 wt. % to about 0.1 wt. %, or from about 0.01 wt. % to about 0.05 wt. %.

In certain embodiments, the surfactant includes a mixture of potassium salts of C6-C20 fatty acids. In certain embodiments, the C6-C20 fatty acids comprises caproic acid, caprylic acid, capric acid, lauric acid, myristic acid, palmitic acid, stearic acid, arachidic acid, oleic acid, linoleic acid, or any combinations thereof. In certain embodiments, at least 40 wt. % of the C6-C20 fatty acids is a saturated C12 fatty acid. The total amount of the mixture of potassium salts of C6-C20 fatty acids in the pest control composition may be from about 0.1 wt. % to about 30 wt. %; from about 0.1 wt. % to about 20 wt. %; from about 0.1 wt. % to about 20 wt. %; from about 0.1 wt. % to about 20 wt. %, from about 0.1 wt. % to about 10 wt. %, from about 0.1 wt. % to about 5 wt. %, from about 0.1 wt. % to about 4 wt. %, from about 0.1 wt. % to about 3 wt. %, from about 0.1 wt. % to about 2 wt. %, from about 0.1 wt. % to about 1.5 wt. %, from about 0.1 wt. % to about 1 wt. %, or from about 0.1 wt. % to about 0.5 wt. %.

The pest control composition disclosed herein may include an active ingredient. The total amount of the active ingredient in the pest control composition may be from about 0.01 wt. % to about 20 wt. %, from about 0.01 wt. % to about 15 wt. %, from about 0.01 wt. % to about 10 wt. %, from about 0.01 wt. % to about 8 wt. %, from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.1 wt. % to about 20 wt. %, from about 0.1 wt. % to about 15 wt. %, from about 0.1 wt. % to about 10 wt. %, from about 0.1 wt. % to about 8 wt. %, from about 0.1 wt. % to about 5 wt. %, from about 0.1 wt. % to about 2.5 wt. %, from about 0.1 wt. % to about 1 wt. %, or from about 0.1 wt. % to about 0.5 wt. %. In certain embodiments, the total amount of the active ingredient in the pest control composition may be about 5 wt. %. In certain embodiments, the total amount of the active ingredient in the pest control composition may be about 0.25 wt. %.

Essential Oil. In certain embodiments, the active ingredient comprises one or more essential oils and/or the constituents thereof. In the pest control field, it is known that consumers desire a product that has a reduced unpleasant, harsh, and lingering chemical odor, without sacrificing efficacy. In certain embodiments, pest control compositions containing one or more essential oils and/or the constituents thereof offer pleasant hedonics and at the same time do not compromise the insect killing/repelling efficacies. Particular strains of certain essential oils may be especially well-suited for use in certain pest control formulations, for example insecticidal or insect repellent formulations. Furthermore, essential oils may offer pleasant hedonics while providing insect killing/repelling efficacies, resulting in pest control products with reduced unpleasant, harsh, and lingering chemical odors. Suitable essential oils include, but are not limited to, 2-phenylethyl propionate, cedarwood oil, cinnamon oil, citronella oil, clove oil, eugenol, garlic oil, geraniol, geranium oil, mint oil (e.g., spearmint oil, peppermint oil, cornmint oil, and mixtures thereof), lemongrass oil, rosemary oil, thyme oil, wintergreen oil, and mixtures thereof.

The total amount of the essential oil in the pest control composition may be from about 0.01 wt. % to about 20 wt. %, from about 0.01 wt. % to about 15 wt. %, from about 0.01 wt. % to about 10 wt. %, from about 0.01 wt. % to about 8 wt. %, from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.1 wt. % to about 20 wt. %, from about 0.1 wt. % to about 15 wt. %, from about 0.1 wt. % to about 10 wt. %, from about 0.1 wt. % to about 8 wt. %, from about 0.1 wt. % to about 5 wt. %, from about 0.1 wt. % to about 2.5 wt. %, from about 0.1 wt. % to about 1 wt. %, or from about 0.1 wt. % to about 0.5 wt. %. In certain embodiments, the total amount of the essential oil in the pest control composition may be about 5 wt. %. In certain embodiments, the total amount of the essential oil in the pest control composition may be about 0.25 wt. %.

In certain embodiments, the active ingredient comprises 2-phenylethyl propionate. In certain embodiments, the total amount of the 2-phenylethyl propionate in the pest control composition may be from about 0.01 wt. % to about 20 wt. %, from about 0.01 wt. % to about 15 wt. %, from about 0.01 wt. % to about 10 wt. %, from about 0.01 wt. % to about 8 wt. %, from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.1 wt. % to about 20 wt. %, from about 0.1 wt. % to about 15 wt. %, from about 0.1 wt. % to about 10 wt. %, from about 0.1 wt. % to about 8 wt. %, from about 0.1 wt. % to about 5 wt. %, from about 0.1 wt. % to about 2.5 wt. %, from about 0.1 wt. % to about 1 wt. %, or from about 0.1 wt. % to about 0.5 wt. %. In certain embodiments, the total amount of the 2-phenylethyl propionate in the pest control composition may be about 5 wt. %. In certain embodiments, the total amount of the 2-phenylethyl propionate in the pest control composition may be about 0.25 wt. %.

In certain embodiments, the active ingredient comprises cedarwood oil. In certain embodiments, the total amount of the cedarwood oil in the pest control composition may be from about 0.01 wt. % to about 20 wt. %, from about 0.01 wt. % to about 15 wt. %, from about 0.01 wt. % to about 10 wt. %, from about 0.01 wt. % to about 8 wt. %, from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.1 wt. % to about 20 wt. %, from about 0.1 wt. % to about 15 wt. %, from about 0.1 wt. % to about 10 wt. %, from about 0.1 wt. % to about 8 wt. %, from about 0.1 wt. % to about 5 wt. %, from about 0.1 wt. % to about 2.5 wt. %, from about 0.1 wt. % to about 1 wt. %, or from about 0.1 wt. % to about 0.5 wt. %. In certain embodiments, the total amount of the cedarwood oil in the pest control composition may be about 5 wt. %. In certain embodiments, the total amount of the cedarwood oil in the pest control composition may be about 0.25 wt. %.

In certain embodiments, the active ingredient comprises geraniol. In certain embodiments, the total amount of the geraniol in the pest control composition may be from about 0.01 wt. % to about 20 wt. %, from about 0.01 wt. % to about 15 wt. %, from about 0.01 wt. % to about 10 wt. %, from about 0.01 wt. % to about 8 wt. %, from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.1 wt. % to about 20 wt. %, from about 0.1 wt. % to about 15 wt. %, from about 0.1 wt. % to about 10 wt. %, from about 0.1 wt. % to about 8 wt. %, from about 0.1 wt. % to about 5 wt. %, from about 0.1 wt. % to about 2.5 wt. %, from about 0.1 wt. % to about 1 wt. %, or from about 0.1 wt. % to about 0.5 wt. %. In certain embodiments, the total amount of the geraniol in the pest control composition may be about 5 wt. %. In certain embodiments, the total amount of the geraniol in the pest control composition may be about 0.25 wt. %.

Cedarwood oil. As used herein, “cedarwood oil” refers to both extracted and synthetic oils produced from distilling wood of a number of different junipers and cypresses (of the family Cupressaceae), and derivatives thereof. Cedarwood oil includes the following CAS registry numbers 85085-29-6,68990-83-0, or 8000-27-9, and may include at least one of the following constituents: α-pinene, α-thujene, Camphene, β-pinene, Sabinene, Myrcene, α-terpinene, Limonene, β-phellandrene, γ-terpinene, p-cymene, Terpinolene, Isolongifolene, β-cubebene, Linalool, α-longipinene, α-cedrene, α-barbatene, β-cedrene, Terpinen-4-ol, β-funebrene, cis-p-menth-2-en-1-ol, Thujopsene (widdrene), allo-aromadendrene, β-barbatene, trans-piperitol, Selina-4,11-diene, δ-chamigrene, α-terpineol, Pseudowiddrene, Bicyclogermacrene, α-cuprenene, Thujopsadiene, δ-cadinene, α-curcumene, β-cuprenene, Cuparene, Dehydro-β-ionone, 8,9-dehydroneolongifolene, α-cedrol, Widdrol, 3-thujopsanone, α-cadinol, α-cedrenal, α-bisabolol, and/or Thujopsenal, Mayurone. In particular embodiments, cedarwood oil may include the following major constituents: Iso-α-cedrene, Thujopsene, Cedrenol, Cuparene, Longifolene, α-Cedrene, β-Cedrene, Cedrol, Widdrol, α-Chamigrene, β-Chamigrene, α-Selinene, β-Himachalenc.

Rosemary oil. As used herein, “rosemary oil” refers to both extracted and synthetic versions of oils from Rosmarinus officinalis, Limonium vulgare, Andromeda polifolia, and derivatives thereof. Further, rosemary oil includes a CAS registry number of 8000-25-7, and may include at least one of the following constituents: tricyclene, alpha-thujene, alpha-pinene, camphene, sabinene, beta-pinene, myrcene, alpha-phellandrene, car-3-ene, alpha-terpinolene, p-cymene, 1,8-cincole, limonene, gamma-terpinene, trans-sabinene, terpinolene, linalool, alpha-campholenol, endo-fenchol, and/or camphor. In particular embodiments, rosemary oil may include the following major constituents: 1,8-cineole, borneol, camphor, verbenone, α-pinene, bornyl acetate, linalool, camphene, β-caryophyllene, α-terpincol, p-cymene, ar-curcumene, 1-nonanol, and terpinen-4-ol.

Spearmint oil. For the purposes of this disclosure, as used herein, “spearmint oil” may refer to both extracted and synthetic versions of Mentha spicata, Mentha crispa, Mentha crispate, Mentha cardiaca G. (scotch spearmint), Mentha spicata L. var. crispa (Bentham) Danert (native spearmint), and/or Mentha viridis, and derivatives thereof. Spearmint is also known as garden mint, common mint, lamb mint, and mackerel mint. Spearmint may also be a species of mint and may be native to Europe and southern temperate Asia, extending from Ireland in the west to southern China in the east. Further, spearmint oil includes a CAS registry number of 8008-79-5. In addition, spearmint oil may have at least one of the following constituents: carvone, d-limonene, (Z)-Dihydrocarvone, menthone, β-myrcene, α-pinene, camphene, sabinene, β-pinene, myrcene, 3-octanol, p-cymene, 1,8-cincole, (Z)-β-ocimene, cis-sabinene hydrate, linalool, cis-p-menth-2-en-1-ol, cis-limonene oxide, trans-limonene oxide, borneol, δ-terpineol, 4-terpineol, α-terpincol, dihydrocarveol, cis-dihydrocarvone, trans-carveol, cis-carveol, pulegone, isobornyl acetate, iso-dihydrocarveol acetate, β-bourbonene, β-elemene, β-caryophyllene, germacrene D, germacrene A, spathulenol, caryophyllene oxide, monoterpene hydrocarbons, oxygenated monoterpenes, sesquiterpene hydrocarbons, and/or oxygenated sesquiterpenes. In particular embodiments, the spearmint oil may have at least the following constituents: carvone, limonene, (Z)-Dihydrocarvone, 3-octanol, menthone, 1,8-cineole, and β-myrcene. Synergistic effects may be achieved when certain components in the pest control composition disclosed here are combined, and in further embodiments, when combined at particular ratios.

Peppermint oil. For the purposes of this disclosure, as used herein, “peppermint oil” may refer to both extracted and synthetic versions of Mentha balsamea Wild, Mentha x piperita L., and derivatives thereof. Peppermint can also be a hybrid mint—a cross between watermint and spearmint. Further, peppermint oil has the CAS registry number 8006-90-4, and may have at least one of the following constituents: menthol, menthone, menthyl acetate, 1,8-cineol, menthofuranne, neomenthol, isomenthone, beta-caryophyllene, germacrene D, limonene, β-pinene, terpinene-4-ol, α-pinene, (6R)-(+)-Menthofuran tr, terpinen-4-ol, (1R)-(+)-β-pulegone, germacrene, β-caryophyllene, (E)-sabinene hydrate, piperitone, and/or isomenthol. In particular embodiments, peppermint oil includes at least the following constituents: menthol, menthone, menthyl acetate, neomenthol, 1,8-cincole, (6R)-(+)-Menthofuran, isomenthone, terpinen-4-ol, (1R)-(+)-β-Pulegone, limonene, germacrene D, β-caryophyllene, (E)-Sabinene hydrate, β-pinene, piperitone, and isomenthol.

Cornmint oil. As used herein, “cornmint oil” may refer to both extracted and synthetic versions of Mentha arvensis, Mentha arvensis L., Mentha arvensis f. piperascens Malinv. Ex Holmes, Mentha arvensis L. var. galbrata Benth, Mentha arvensis L. var. villosa Benth, Mentha canadensis L., and derivatives thereof. Further, cornmint oil has a CAS registry number 68917-18-0. Cornmint is also known as field mint or wild mint. Further, like spearmint oil and peppermint oil, cornmint oil is a species of flowering plant in the mint family Lamiaceae. Cornmint oil may also have at least one of the following constituents: cis-beta-ocimene, β-phellandrene, gamma-terpinene, terpinolene, α-pinene, neomenthol, santene, α-thujene, p-cymene, β-farnesene, β-caryophyllene, betabourbonene, myrcene, β-myrcene, α-terpinene, delta-terpinene, limonene, β-pinene, camphene, sabinene, germacrene D, gamma-caryophyllene, delta-cardinene, ethanol, 3-methylbutanol, 3-octanol, citronellolnerol, menthol, isomenthol, α-terpincol, isopulegol, cis-carveol, pmenthan-2,5-diol, isocaryophyllenol, butanol, (Z)-3-hexenol, 2,6-nonadienol, geraniol, neoisomenthol, terpinen-4-ol, neoiso (iso) pulegol, trans-carveol, borneol, viridiflorol, acetaldehyde, 3-methylbutanal, geranial, 2-methylpropanal, 2,6-nonadienal, neral, acetone, 2-heptanone, 2-isopropylcyclopentanone, 3-methylcyclohexanone, menthone, piperitone, carvone, 2-butanone, methylheptenone, cis-jasmone, carvomenthone, isomenthone, pulegone, (1R)-(+)-β-pulegone, iso-isopulegol, formic acid, 3-methylbutanoic acid, hexanoic acid, nonanoic acid, acetic acid, pentanoic acid, (E)-2-hexenyl acetate, (Z)-3-hexenyl acetate, 1-octen-3-yl acetate, geranyl acetate, linalyl acetate, menthyl acetate, isomenthyl acetate, neomenthyl acetate, neoisomenthyl acetate, dihydrocarvyl acetate, (Z)-3-hexenyl 3-methylbutanoate, menthyl 3-methylbutanoate, menthyl pentanoate, (Z)-3-hexenyl hexanoate, menthyl hexanoate, (Z)-3-hexenyl 2-hydroxybenzoate, (E)-2-hexenyl phenylacetate, (Z)-3-hexenyl phenylacetate, 3-phenylpyridine, 3-phenyl-4-propylpyridine, menthofuran, menthofurolactone, 1,8-cincole, trans-2,5-diethylfuran, 3-(5,5-dimethyltetrahydro-2-furyl)-(Z)-2-butenol-1, piperitone oxide, beta-caryophyllene oxide, and/or 2-isopropyl-5-methylphenol (thymol). In particular embodiments, cornmint oil may include the following major constituents: menthol and menthone.

Geranium oil. As used herein, “geranium oil” refers to both extracted and synthetic oils of geranium, and derivatives thereof. Geranium is a genus of 422 species of annual, biennial, and perennial plants that are commonly known as geraniums or cranesbills. Geranium oil has the CAS registry number 8000-46-2 and at least one of the following constituents: citronellol, geraniol, linalool, citronellyl formiate, menthone, geranyl-formiate, 3,7-gvaiedien, alpha-terpineol, izomenthon, beta-burbonen, tetrahydrogeraniol, alpha-pinene, geranyl-butyrate, linalyl-propionate, cis-rozokside, geranyl-tiglate, beta-caryophyllene, citronellyl-propionate, citronellyl-butyrate, calamenen, neryl-propionate, benzylidene camphor, geranyl-propionate, and/or delta-gvaien. In particular embodiments, geranium oil may include the following major constituents: Citronellol, Citronellyl formate, Geraniol, Guaia-6,9-diene, Isomenthone, Linalool, Menthone, Geranyl formate, (Z)-+ (E)-Rose oxide, Germacrene, Geranyl tiglate, Citronellyl propionate, β-Caryophyllene, Citronellyl tiglate, Geranyl butyrate, β-Bourbonene.

Cinnamon oil. As used herein, “cinnamon oil” refers to both extracted and synthetic oils of species from the genus Cinnamomum in the family Lauraceae, and derivatives thereof. Cinnamon oil has the CAS registry number 8015-91-6 and can have at least one of the following constituents: benzenepropanal, borneol, 3-phenyl-2-propenal, trans-cinnamaldehyde, (+)-cyclosativene, alpha-cubebene, (+)-sativene, 1-caryophyllene, gamma-muurolene, gamma-maaliene, alpha-muurolene, 1,2,4a,5,6,8a-hexahydro-4,7-dimethyl-1-(1-methylethyl) naphthalene, d-cadinene, 1,6-dimethyl-4-(1-methyletyhl)-(1,2,3,4,4a,7) hexahydronaphthalene, 1,1,6-trimethyl-1,2-dihydronaphthalene, t-muurolol, and/or alpha-copaene. In particular embodiments, cinnamon oil may include the following major constituents: Eugenol, Eugenyl acetate, Linalool, (E)-Cinnamyl acetate, Benzyl benzoate, β-Caryophyllene, (E)-Cinnamaldehyde, Safrole, Cinnamyl alcohol.

Particular strains of certain essential oils may be especially well-suited for use in certain oil-based insect repellent formulations. For the purposes of this disclosure, “peppermint oil” is defined to be the oil of Mentha arvenis, the oil of Mentha piperita, and any combination thereof. For example, in certain formulations, it is particularly advantageous to use the Arvensis strain of peppermint oil (i.e. Mentha arvenis). The oil of Mentha arvenis is sometimes commonly referred to as cornmint oil. Without wishing to be bound by any particular theory, Mentha arvenis oil may be particularly advantageous due to the unusually high levels of menthol that it contains. One skilled in the art will appreciate that Mentha arvenis oil may be difficult to use in certain liquid formulations, as its menthol levels are so high that when distilled the oil is usually solid. One skilled in the art will also recognize that it may be particularly advantageous to configure any and/or all of the embodiments disclosed herein such that some or all of the peppermint oil in a given embodiment is Mentha arvenis oil. Additionally, in certain formulations, it may be particularly advantageous to use the Piperita strain of peppermint oil (i.e. Mentha piperita). One skilled in the art will appreciate that Mentha piperita oil may be difficult to use in certain liquid formulations, for reasons similar to those discussed above with respect to Mentha arvenis oil. However, one skilled in the art will also recognize that it may be particularly advantageous to configure any and/or all of the embodiments disclosed herein such that some or all of the peppermint oil in a given embodiment is Mentha piperita oil. As another example, in certain formulations, it may be advantageous to use a particular type of clove oil, such as clove bud oil, clove leaf oil, or clove stem oil. Without wishing to be bound by any particular theory, different types of clove oil may commonly contain different concentrations of eugenol, which may affect the repellency/efficacy of the particular type of clove oil. Typically, clove bud oil has 60-90 wt % eugenol, clove leaf oil has 70-82 wt % eugenol, and clove stem oil has 85-92 wt % eugenol. One skilled in the art will also recognize that it may be particularly advantageous to configure any and/or all of the embodiments disclosed herein such that some or all of the clove oil in a given embodiment is any one of clove oil, such as clove bud oil, clove leaf oil, clove stem oil, or a combination thereof. As still another example, in certain formulations, it may advantageous to use a particular strain of geranium oil, such as the Egyptian strain of geranium oil or the Bourbon strain of geranium oil. One skilled in the art will also recognize that it may be particularly advantageous to configure any and/or all of the embodiments disclosed herein such that some or all of the geranium oil in a given embodiment is any one of the Egyptian strains of geranium oil, the Bourbon strain of geranium oil, or a combination thereof.

Other plant-based natural oil or natural oil extract that may be contained in the embodiments of the pest control compositions described herein may comprise neem oil, karanja oil, clove oil, thyme oil, oregano oil, garlic oil, anise oil, lime oil, lavender oil, thymol (found in oregano oil and thyme oil), p-cymene (found in oregano oil and thyme oil), 1,8-cincole (found in thyme oil and peppermint oil), eugenol (found in clove oil and cinnamon oil), limonene (found in cinnamon, peppermint, and lime oil), alpha-pinene (found in cinnamon oil, geranium oil, and lime oil), carvacrol (found in oregano oil, thyme oil, and clove oil), gamma-terpinene (found in oregano oil and lime oil), geraniol (found in thyme oil and geranium oil), alpha-Terpineol (found in thyme oil and anise oil), beta-caryophyllene (found in clove oil, cinnamon oil, and peppermint oil) and linalool (found in thyme oil, cinnamon oil and geranium oil, amongst others), or mixtures thereof. In other embodiments, the pest control natural oil may comprise any oil having as a constituent one of the following compounds, or a combination of the following compounds: azadirachtin, nimbin, nimbinin, salannin, gedunin, geraniol, geranial, gamma-terpinene, alpha-terpin-col, beta-caryophyllene, terpinen-4-ol, myrcenol-8, thuya-nol-4, benzyl alcohol, cinnamaldehyde, cinnamyl acetate, alpha-pinene, geranyl acetate, citronellol, citronellyl formate, isomenthone, 10-epi-gamma-cudesmol, 1,5-dimethyl-1-vinyl-4-hexenylbutyrate, 1,3,7-octatriene, cucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cin-cole, eugenol, limonene, alpha-pinene, menthol, menthone, linalool, or mixtures thereof.

In further embodiments, other plant-based natural oil or natural oil extract that may be contained in the embodiments of the pest control compositions described herein may comprise alpha- or beta-pinene; alpha-camp-holenic aldehyde; alpha-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lamda-terpinene; achillea; aldehyde C16 (pure); allicin; alpha-phellandrene; amyl cinnamic aldehyde; amyl salicylate; anethole; anise; anisced; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borncol; calamus; camphor; cananga oil (e.g., java); cardamom; carnation (e.g., dianthus caryophyllus); carvacrol; carveol; cassia; castor; cedar (e.g., hinoki); chamomile; cincole; cinnamaldehyde; cinnamic alcohol; cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; d-dihydrocarvone; decyl aldehyde; diallyl disulfide; diethyl phthalate; dihydroanethole; dihydrocarveol; dihydrolinalool; dihydromyrcene; dihydromyrcenol; dihydromyrcenyl acetate; dihydroterpincol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); cucalyptol (e.g., cincole); eucalyptus citriodora; eucalyptus globulus; eucalyptus; eugenol (e.g., 2-methoxy-4-allyl phenol); evening primrose; fenchol; fennel; Femiol™; fish; florazon (e.g., 4-ethyl-. alpha., .alpha.-dimethyl-benzenepropanal); galaxolide; geraniol (e.g., 2-trans-3,7-dimethyl-2,6-octadien-8-ol); geraniol; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; i-methylacetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalyl acetate; linseed; litsea cubeba; I-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methylcyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., Citrus aurantium dulcis); orris (e.g., Iris florentina) root; para-cymene; para-hydroxy phenyl butanone crystals (e.g., 4-(4-hydroxphenyl)-2-butanone); passion palmarosa oil (e.g., Cymbopogon martini), patchouli (e.g., Pogostemon cablin), p-cymene; pennyroyal oil; pepper; peppermint (e.g., Mentha piperita), perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., Rosmarinus officinalis), ryu; sage; sandalwood (e.g., Santa-lum album), sandenol; sassafras; sesame; soybean; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thymc; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, or mixtures thereof.

Other suitable essential oils for use in the pest control compositions described herein include Absinth Oil, Almond Oil, Ambrette Seed Oil, Amyris Oil, Angelica Root Oil, Ancthole 20/21 natural, Angelica Seed Oil, Aniseed Oil China star, Anise Star Oil, Balsam Fir Oil, Balsam Oil, Basil Oil, Bay Oil, Bergamot Oil, Birch Sweet Oil, Birch Tar Oil, Bitter Almond Oil, Bitter Orange Oil Cold Pressed, Black Pepper Oil Black Pepper Oleoresin 40/20, Bois de Rose, Buchu Oil, Cabreuva Oil, Cade Oil, Cajeput Oil, Calamus Oil, Camphor Oil White, Cananga Oil, Capsicum Oil, Caraway Seed Oil, Cardamom Seed Oil, Carrot Seed Oil, Cassia Oil, Cedar leaf Oil, Cedarwood Oil, Celery Leaf Oil, Celery Seed Oil, Chamomile Flower Oil, Chenopodium Oil (Wormseed), Cinnamon Bark Oil, Cinnamon Leaf Oil, Cistus Oil, Citronella Oil, Citronellol Terpenes, Clary Sage Oil, Clove Bud Oil, Clove Leaf Oil, Clove Stem Oil, Cognac Oil Green, Cognac Oil White, Copaiba Oil, Coriander Leaf Oil, Coriander Seed Oil, Cornmint Oil (Mentha Arvensis), Cumin Seed Oil, Cyclamen Oil, Cypress Oil, Davana Oil, Dill Herb Oil, Erigeron Oil, Estragon Oil (Tarragon Oil), Eucalyptus Oil, Fennel Oil Bitter, Fennel Oil Sweet, Fir Needle Oil, Galbanum Oil, Garlic Oil, Geranium Oil, Ginger Oil, Grapefruit Oil 10-Fold, Grapefruit Oil 5-Fold, Grapefruit Oil Cold Pressed, Grapefruit Oil Terpenes, Guaiac Wood Oil, Gurjun Balsam, Hemlock Oil (Spruce), Ho Leaf Oil, Ho Wood Oil, Hyssop Oil, Jasmin Oil, Juniper Berry Oil, Laurel Leaf Oil, Lavandin Oil, Lavender Oil, Lavender Spike Oil, Lemon Oil 10-Fold, Lemon Oil 5-Fold, Lemon Oil Cold Pressed, Lemon Oil Distilled, Lemon Oil Terpenes, Lemon Oil Washed, Lemongrass Oil, Lemongrass Oil Terpeneless, Lime Oil 5-Fold, Lime Oil Distilled, Lime Oil Terpenes, Lime Oil Washed, Litsea Cubeba Berry Oil, Mace Oil, Mandarin Oil Cold Pressed, Marjoram Oil Sweet, Musk Oil, Myrtel Oil, Neroli Oil, Nutmeg Oil, Ocotea Cymbarum Oil, Onion Oil, Orange Oil Bitter Cold Pressed, Orange Oil 10-Fold, Orange Oil20-Fold, Orange Oil 5-Fold, Orange Oil Bitter 5-Fold, Orange Oil Cold Pressed, Orange Oil Terpeneless, Oregano Oil, Origanum Oil, Palmarosa Oil, Parsley Leaf Oil, Parsley Seed Oil, Patchouli Oil, Pennroyal Oil, Pepper Oil Black, Peppermint Oil, Petitgrain Oil, Pimenta Berry Oil, Pimenta Leaf Oil, Pine Needle Oil, Pine Oil Scotch, Pine Oil White, Rosalin Oil, Rose Oil, Sage Clary Oil, Sage Oil, Sandalwood Oil, Sassafras Oil, Savory Oil, Spike Lavender Oil (Lavender Spike), Spruce Oil (Hemlock), Star Anise Oil, Styrax Oil, Tagetes Oil, Tangelo Oil, Tangerine Oil, Tangerine Oil 5-Fold, Tangerine Oil Terpenes, Tarragon Oil (Estragon Oil), Tea Tree Oil, Thyme Oil, Thyme Oil White, Tumeric Oil, Purpentine Oil, Valerian Oil, Vanilla beans abs., Vetiver Oil, Wintergreen Oil (Methyl Salicylate Natural), Wormseed Oil, Wormwood Oil, and Ylang Ylang Oil.

The compositions of the present disclosure, and the active ingredient thereof, may also include other active ingredients other than or in addition to essential oils.

Solvent. The pest control composition disclosed herein may include a solvent, for example to dissolve certain components, to enhance functionality of the components, or for textural and sensorial attributes. In certain embodiments, the solvent may achieve a synergistic effect with the soap by improving the efficiency of the soap in solubilizing the active ingredient (e.g., essential oil), leading to a clear, colorless, and single-phased appearance of the pest control composition across a wide range of temperature conditions. In certain embodiments, the solvent also provide benefit to the consumer in making the formula easy to clean up from a surface. The resulting composition may also stay stable across a range of temperatures. Suitable solvents include, but are not limited to, ethyl lactate, butyl lactate, isopropyl alcohol, isopropyl myristate, acetyl tributyl citrate, triethyl citrate, glycerin, and/or combinations thereof.

In certain embodiments, the pest control composition comprises at least 1 wt. %, at least 3 wt. %, at least 5 wt. %, at least 10 wt. %, or at least 15 wt. % of the solvent. The total amount of the solvent in the pest control composition may be from about 1 wt. % to about 60 wt. %; from about 1 wt. % to about 50 wt. %; from about 1 wt. % to about 40 wt. %; from about 1 wt. % to about 30 wt. %; from about 1 wt. % to about 20 wt. %; from about 1 wt. % to about 15 wt. %; from about 5 wt. % to about 60 wt. %; from about 5 wt. % to about 50 wt. %, from about 5 wt. % to about 40 wt. %, from about 5 wt. % to about 30 wt. %, from about 5 wt. % to about 20 wt. %, or from about 5 wt. % to about 15 wt. %. In certain embodiments, the total amount of the solvent in the pest control composition may be about 20 wt. %. In certain embodiments, the total amount of the solvent in the pest control composition may be about 10 wt. %.

In certain embodiments, the solvent includes isopropyl alcohol. In certain embodiments, the total amount of the isopropyl alcohol in the pest control composition may be from about 1 wt. % to about 60 wt. %; from about 1 wt. % to about 50 wt. %; from about 1 wt. % to about 40 wt. %; from about 1 wt. % to about 30 wt. %; from about 1 wt. % to about 20 wt. %; from about 1 wt. % to about 15 wt. %; from about 5 wt. % to about 60 wt. %; from about 5 wt. % to about 50 wt. %, from about 5 wt. % to about 40 wt. %, from about 5 wt. % to about 30 wt. %, from about 5 wt. % to about 20 wt. %, or from about 5 wt. % to about 15 wt. %. In certain embodiments, the total amount of isopropyl alcohol in the pest control composition may be about 20 wt. %. In certain embodiments, the total amount of isopropyl alcohol in the pest control composition may be about 10 wt. %.

In certain embodiments, the solvent consists essentially of isopropyl alcohol. In certain embodiments, the solvent consists of isopropyl alcohol. In certain embodiments, the solvent and the pest control composition are free of propylene glycol.

Salt. The pest control composition disclosed herein may include a salt. The salt may enhance the functionality of certain components. For example, the salt can help anionic surfactants, such as soap, better solubilize oils in aqueous solutions by providing counterions to the reduce intermolecular repulsive forces of the negatively charged poles on the anionic surfactant, which impacts the packing configuration of the surfactant micelles. Therefore, in certain embodiments, the salt may achieve a synergistic effect with the soap and the solvent by improving the efficiency of the soap in solubilizing the active ingredient (e.g., essential oil), leading to a clear, colorless, and single-phased appearance of the pest control composition. The resulting composition may also stay stable across a range of temperatures. In certain embodiments, the addition of salt, such as sodium chloride, allows an unexpectedly lower usage level of surfactant that is needed to solubilize the active ingredient, leading to an improved cost profile. Therefore, in some embodiments, the total amount of surfactant and the total amount of active ingredient have a weight ratio of equal to or less than 5:1, equal to or less than 4:1, or equal to or less than 3:1 with the addition of salt.

Suitable salts include, but are not limited to, alkali metal chlorides such as sodium chloride, lithium chloride, and potassium chloride.

In certain embodiments, the pest control composition comprises at least 0.005 wt. %, at least 0.01 wt. %, or at least 0.02 wt. % of the salt. The total amount of the salt in the pest control composition may be from about 0.005 wt. % to about 0.5 wt. %; from about 0.005 wt. % to about 0.1 wt. %; from about 0.005 wt. % to about 0.05 wt. %; from about 0.005 wt. % to about 0.04 wt. %, from about 0.005 wt. % to about 0.03 wt. %, from about 0.01 wt. % to about 0.025 wt. %, or from about 0.015 wt. % to about 0.025 wt. %. In certain embodiments, the total amount of salt in the pest control composition may be about 0.02 wt. %.

In certain embodiments, the salt includes sodium chloride. In certain embodiments, the pest control composition includes from about 0.005 wt. % to about 0.5 wt. % of sodium chloride. In certain embodiments, the pest control composition includes from about 0.005 wt. % to about 0.1 wt. % of sodium chloride. In certain embodiments, the pest control composition includes from about 0.005 wt. % to about 0.05 wt. % of sodium chloride. In certain embodiments, the pest control composition includes from about 0.005 wt. % to about 0.04 wt. % of sodium chloride. In certain embodiments, the pest control composition includes from about 0.005 wt. % to about 0.03 wt. % of sodium chloride. In certain embodiments, the pest control composition includes from about 0.01 wt. % to about 0.025 wt. % of sodium chloride. In certain embodiments, the pest control composition includes from about 0.015 wt. % to about 0.025 wt. % of sodium chloride. In certain embodiments, the pest control composition includes about 0.02 wt. % of sodium chloride.

Carrier. The term “carrier” as used herein means a material, which can be inorganic or organic and of synthetic or natural origin, with which the active compound is mixed or formulated to facilitate its application to the host, area, or other object to be treated, or to facilitate its storage, transport and/or handling. In general, any of the materials customarily employed in formulating repellents, pesticides, herbicides, or fungicides, are suitable.

In certain embodiments, the carrier comprises water, and in particular embodiments, the carrier is water. The water component may be purified water, deionized water, reverse osmosis water, distilled water, tap water, and/or the like.

The total amount of water in the pest control composition may be from about 40 wt. % to about 95 wt. %, from about 40 wt. % to about 90 wt. %, from about 40 wt. % to about 80 wt. %, from about 40 wt. % to about 70 wt. %, from about 40 wt. % to about 60 wt. %, from about 50 wt. % to about 95 wt. %, from about 50 wt. % to about 90 wt. %, from about 50 wt. % to about 80 wt. %, from about 50 wt. % to about 70 wt. %, from about 50 wt. % to about 60 wt. %, from about 60 wt. % to about 95 wt. %, from about 60 wt. % to about 90 wt. %, or from about 60 wt. % to about 80 wt. %. In certain embodiments, the total amount of water in the pest control composition may be about 55 wt. %. In certain embodiments, the total amount of water in the pest control composition may be about 87 wt. %.

In certain embodiments, the total amount of surfactant and the total amount of active ingredient have a weight ratio of at least 2:1, at least 3:1, at least 4:1, at least 5:1, at least 6:1, at least 7:1, at least 8:1, at least 9:1, at least 10:1, at least 11:1, at least 12:1, at least 13:1, at least 14:1, at least 15:1, or at least 20:1 in the pest control composition. In certain embodiments, the total amount of surfactant and the total amount of active ingredient have a weight ratio of equal to or less than 15:1, equal to or less than 10:1, equal to or less than 9:1, equal to or less than 8:1, equal to or less than 7:1, equal to or less than 6:1, equal to or less than 5:1, equal to or less than 4:1, or equal to or less than 3:1. In certain embodiments, the total amount of the surfactant and the total amount of the active ingredient have a weight ratio of from about 1:1 to about 20:1. In certain embodiments, the total amount of the surfactant and the total amount of the active ingredient have a weight ratio of from about 2:1 to about 20:1. In certain embodiments, the total amount of the surfactant and the total amount of the active ingredient have a weight ratio of from about 2:1 to about 18:1. In certain embodiments, the total amount of the surfactant and the total amount of the active ingredient have a weight ratio of from about 2:1 to about 15:1. In certain embodiments, the total amount of the surfactant and the total amount of the active ingredient have a weight ratio of from about 2:1 to about 10:1. In certain embodiments, the total amount of the surfactant and the total amount of the active ingredient have a weight ratio of from about 2:1 to about 6:1. In certain embodiments, the total amount of the surfactant and the total amount of the active ingredient have a weight ratio of about 4:1. In certain embodiments, the total amount of the surfactant and the total amount of the active ingredient have a weight ratio of about 3:1. In certain embodiments, the surfactant may comprise potassium cocoate and the active ingredient may comprise one or more essential oils. In certain embodiments, the surfactant may comprise a mixture of potassium salts of C6-C20 fatty acids and the active ingredient may comprise one or more essential oils. In certain embodiments, the weight ratio described herein allows the formulation to maintain a clear, colorless solution that is stable across a range of temperatures.

In certain embodiments, the composition may include one or more additional ingredients, such as an inert component, or an active ingredient other than or in addition to essential oils. In certain embodiments, a suitable pH adjusting agent may be provided, such as sodium hydroxide, sodium carbonate, sodium bicarbonate, or an acid, for instance an organic acid such as citric acid, lactic acid, or acetic acid. Certain pH adjusting agents may also impart insecticidal or insect repellant properties or may work synergistically with other components to enhance the properties of the composition, for instance, citric acid. The total amount of the pH adjusting agent in the pest control composition may be from about 0.01 wt. % to about 20 wt. %, from about 0.01 wt. % to about 15 wt. %, from about 0.01 wt. % to about 10 wt. %, from about 0.01 wt. % to about 8 wt. %, from about 0.01 wt. % to about 5 wt. %, from about 0.01 wt. % to about 2.5 wt. %, from about 0.01 wt. % to about 1 wt. %, from about 0.01 wt. % to about 0.5 wt. %, from about 0.1 wt. % to about 20 wt. %, from about 0.1 wt. % to about 15 wt. %, from about 0.1 wt. % to about 10 wt. %, from about 0.1 wt. % to about 8 wt. %, from about 0.1 wt. % to about 5 wt. %, from about 0.1 wt. % to about 2.5 wt. %, from about 0.1 wt. % to about 1 wt. %, or from about 0.1 wt. % to about 0.5 wt. %. In certain embodiments, the total amount of the pH adjusting agent in the pest control composition may be about 5 wt. %. In certain embodiments, the total amount of the pH adjusting agent in the pest control composition may be about 0.25 wt. %.

In certain circumstances, the composition may include one or more ingredients that are compliant with the California Air Resource Board (CARB) Volatile Organic Compound (VOC) requirements.

In certain circumstances, the composition may include one or more ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25 (f), for example, included, but not limited to, those listed as “Active Ingredients Permitted in Exempted Minimum Risk Pesticide Products” in 40 U.S. Code of Federal Regulations 152.25 (f).

In certain embodiments, the pest control composition described herein may be free of palm-oil derivatives.

In certain embodiments, the pest control composition described herein is single-phased between about 0° C. to about 25° C., or between about 0° C. to about 54° C.

In certain embodiments, the pest control composition described herein is clear and colorless between about 0° C. to about 25° C., or between about 0° C. to about 54° C.

In certain embodiments, the pest control composition described herein has a low viscosity and could be dispensed through a trigger sprayer. In certain embodiments, the pest control composition described herein has a dynamic viscosity of less than about 1.4 mPas, less than about 1.3 mPas, less than about 1.2 mPa·s, less than about 1.1 mPa·s, less than about 1.00 mPa·s, or less than about 0.90 mPas at 20° C. and standard pressure.

In certain embodiments, the pest control composition described herein may remain stable on the shelf or throughout the supply chain without compromised performances between about 0° C. to about 25° C., or between about 0° C. to about 54° C. for at least 1 year, at least 1.5 years, at least 2 years, at least 2.5 years, or at least 3 years.

In certain embodiments, the pest control composition described herein may achieve a pest mortality rate of at least 60%, at least 65%, at least 70%, at least 75%, at least 80%, at least 85%, at least 90%, at least 95%, at least 96%, at least 97%, at least 98%, at least 99%, or 100% in 24 hours for at least arthropods including insects and arachnids, such as German cockroaches, American cockroaches, ants, ticks, spiders, mosquitoes, and mites when tested as described herein.

In certain embodiments, the pest control composition described herein may achieve a pest knockdown rate of at least 60%, at least 65%, at least 70%, at least 75%, at least 80%, at least 85%, at least 90%, at least 95%, at least 96%, at least 97%, at least 98%, least 99%, or 100% at 15 seconds, 30 seconds, 60 seconds, 90 seconds, 2 minutes, 3 minutes, 4 minutes, or 5 minutes for at least arthropods including insects and arachnids, such as German cockroaches, American cockroaches, ants, ticks, spiders, mosquitoes, and mites when tested as described herein.

Any of the embodiments described herein may be modified to include any of the structures, compositions, or methodologies disclosed in connection with different embodiments.

### EXAMPLES

The following Examples are provided to demonstrate and further illustrate certain embodiments and aspects of the present disclosure and are not to be construed as limiting the scope of the disclosure.

Unless stated otherwise, the efficacy tests were conducted in accordance with the U.S. Environmental Protection Agency Product Performance Test Guidelines, OCSpp 8103500: Premises Treatments, which provides recommendations for the design and execution of laboratory and field studies to evaluate the performance of pesticide products applied in or around premises in connection with registration of pesticide products under the Federal Insecticide, Fungicide, and Rodenticide Act (FIFRA) (7 U.S.C. 136, et seq.). The entire contents of these testing guidelines are incorporated by reference herein.

To achieve a formula that is easy to clean up for the consumer, the formula is preferred to be water-based. Some of the minimum-risk pesticide products in market today are primarily composed of mineral oil and other hydrophobic ingredients. These products leave behind a greasy residue on surfaces after being used, which is not easily wiped up by the consumer. These products often instruct the consumer to clean the product up with soap and water. Having a water-based formula would eliminate this extra cleanup step.

The challenge with a water-based formula is the ability to solubilize the active ingredients into the formula while keeping it clear and colorless. The active ingredients identified as options for this formula were several of the essential or naturally derived oils that are compliant with the EPA's minimum-risk pesticide regulation, including 2-phenylethyl propionate, cedarwood oil, cinnamon oil, citronella oil, cornmint oil, eugenol, garlic oil, geraniol, geranium oil, lemongrass oil, peppermint oil, rosemary oil, spearmint oil, and/or thyme oil. These active ingredients can provide efficacy in killing or repelling insects and as well as a pleasant fragrance experience for the consumer. However, they are all hydrophobic and are not soluble in water on their own. Therefore, to create a single phase, clear, colorless, solution, surfactants and/or solvents were needed in the formula.

A majority of the surfactants listed for use in minimum-risk pesticides that are also commercially available are palm oil derivatives. Considering the sustainability commitment to avoid the use of palm oil-derived materials, soap was identified as a non-palm option, which can be produced from non-palm sources.

### Example 1

The type of soap used in this work was potassium cocoate, derived from coconut oil, because it is widely available, easily soluble in water, and has good ability to solubilize oils in water-based systems. Oil solubility trials with potassium cocoate as well as a few palm-derived surfactants are shown in Table 2 below. This testing was done to see how well the surfactants could solubilize an active ingredient in water. Potassium cocoate was the only surfactant tested that eventually resulted in the desired clear, colorless, and low viscosity solution. The other surfactants created hazy solutions or thick gels/creams that did not meet the desired physical characteristics for the formula.

TABLE 2
Active ingredient solubility in water with different surfactants.

| | | Palm Oil | |
|---|---|---|---|
| Formula | Composition | Derivatives? | Appearance |
| CR-425-12- | 89 wt. % Water | Yes | Hazy |
| B1 | 10% wt. Potassium Oleate | | |
| | 1 wt. % Rosemary Oil | | |
| CR-425-12- | 89 wt. % Water | Yes | Milky white |
| C1 | 10 wt. % Sodium Oleate | | gel |
| | 1 wt. % Rosemary Oil | | |
| CR-425-12- | 89 wt. % Water | Yes | Hazy cream |
| D1 | 10 wt. % Potassium | | |
| | Stearate | | |
| | 1 wt. % Rosemary Oil | | |
| CR-425-12- | 89 wt. % Water | No | Starts hazy, |
| A1 | 10 wt. % Potassium Cocoate | | turns clear |
| | 1 wt. % Rosemary Oil | | over time |

### Example 2

There was desire to further improve the formula containing potassium cocoate by getting to a clear and colorless solution instantly upon production and also decreasing the surfactant load in the formula to improve the cost profile. To achieve this, a solvent, isopropanol, was added to the formula to determine if this would improve the emulsification of the oil into solution. Isopropanol is compliant with the EPA's minimum-risk pesticide regulation and is compatible with both water and the active ingredients. It could also provide benefits to the consumer in making the formula easy to clean up from a surface.

As seen in Table 3 below, when 10 wt. % isopropanol was added to the solution, the formula was clear, colorless and freeze/thaw stable when the surfactant to oil ratio is greater than 10:1 for rosemary oil, and at least 10:1 for 2-phenylethyl propionate (2-PeP). Samples CR-425-12-A4 and CR-425-13-A1 showcased how different active ingredients can behave differently in the same base formulas. When higher levels of active ingredient were added, higher levels of surfactant and solvent were preferred to achieve a clear, colorless solution that is freeze/thaw stable. However, with decreased levels of active ingredient, reduced amount of surfactant and solvent may be used (e.g., Example 6). With 5 wt. % 2-PeP in solution, 25 wt. % of potassium cocoate and 20 wt. % of isopropanol were used to create the desired stable solution.

TABLE 3
Solvent addition and freeze/thaw stability assessment.

| | Active | | | | F/T |
|---|---|---|---|---|---|
| Formula | Ingredient | Surfactant | Solvent | Appearance | Stable? |
| CR-425-12- | 1 wt. % | 10 wt. % | 0% | Starts hazy, turns | N |
| A1 | Rosemary Oil | Potassium | | clear over time | |
| | | Cocoate | | | |
| CR-425-12- | 1 wt. % | 10 wt. % | 10 wt. % | Clear, colorless | N |
| A4 | Rosemary Oil | Potassium | Isopropanol | | |
| | | Cocoate | | | |
| CR-425-12- | 1 wt. % | 17 wt. % | 10 wt. % | Clear, colorless | Y |
| A3 | Rosemary Oil | Potassium | Isopropanol | | |
| | | Cocoate | | | |
| CR-425-13- | 1 wt. % | 10 wt. % | 10 wt. % | Clear, colorless | Y |
| A1 | 2-Phenylethyl | Potassium | Isopropanol | | |
| | Propionate | Cocoate | | | |
| CR-425-12- | 5 wt. % | 10 wt. % | 10 wt. % | Milky white, | — |
| A2 | Rosemary Oil | Potassium | Isopropanol | separates into two | |
| | | Cocoate | | phases | |
| CR-425-13- | 5 wt. % | 20 wt. % | 20 wt. % | Clear, colorless | N |
| A28 | 2-Phenylethyl | Potassium | Isopropanol | | |
| | Propionate | Cocoate | | | |
| CR-425-13- | 5 wt. % | 25 wt. % | 10 wt. % | Clear, colorless | N |
| A26 | 2-Phenylethyl | Potassium | Isopropanol | | |
| | Propionate | Cocoate | | | |
| CR-425-13- | 5 wt. % | 25 wt. % | 15 wt. % | Clear, colorless | N |
| A29 | 2-Phenylethyl | Potassium | Isopropanol | | |
| | Propionate | Cocoate | | | |
| CR-425-13- | 5 wt. % | 25 wt. % | 20 wt. % | Clear, colorless | Y |
| A31 | 2-Phenylethyl | Potassium | Isopropanol | | |
| | Propionate | Cocoate | | | |

### Example 3

To further improve the oil emulsifying efficiency of the surfactant, experiments were performed exploring the addition of salt, such as sodium chloride to the formula. Potassium cocoate is an anionic surfactant, and salt is able to help this type of surfactant better solubilize oils in aqueous solutions by providing counterions to the reduce intermolecular repulsive forces of the negatively charged poles on the anionic surfactant, which impacts the packing configuration of the surfactant micelles. Table 4 below shows results from experiments that were again performed by adding the listed materials to scintillation vials, adding water to get to a 100% solution and shaking the vial to mix after each material addition. All of the formulas listed in Table 4 were made with 5 wt. % 2-phenylethyl propionate and 20 wt. % isopropanol in solution. The appearance was determined through visual observation and the formulas that were clear and colorless were subjected to one round of freeze/thaw testing. As seen in the table below, adding salt decreased the surfactant loading from 25 wt. % (CR-425-13-A31) to 20 wt. % (CR-425-13-A22) to create a clear, colorless, stable solution. This reduction in surfactant is desirable to reduce the amount of raw material needed in the formula and improve the cost profile. At this oil and solvent load, going below 20 wt. % surfactant load resulted in an unstable surfactant load. However, with decreased oil and solvent load, a lower amount of surfactant may be used (e.g., Example 6). Changing the concentration of salt in the solution did not have any impact on the appearance or stability of the formula between 0.02 wt. % and 0.5 wt. %.

TABLE 4
Salt addition to 5 wt. % 2-PeP, 20
wt. % isopropanol aqueous solutions

| | Potassium | | | | F/T |
|---|---|---|---|---|---|
| Formula | Cocoate | | Salt | Appearance | Stable? |
| CR-425-13-A10 | 25 | wt. % | 0.25 wt. % | Clear, | Y |
| | | | | colorless | |
| CR-425-15-1 | 25 | wt. % | 0.02 wt. % | Clear, | Y |
| | | | | colorless | |
| CR-425-13-A16 | 20 | wt. % | 0.25 wt. % | Clear, | Y |
| | | | | colorless | |
| CR-425-13-A20 | 20 | wt. % | 0.10 wt. % | Clear, | Y |
| | | | | colorless | |
| CR-425-13-A21 | 20 | wt. % | 0.05 wt. % | Clear, | Y |
| | | | | colorless | |
| CR-425-13-A22 | 20 | wt. % | 0.02 wt. % | Clear, | Y |
| | | | | colorless | |
| CR-425-13-A12 | 15 | wt. % | 0.25 wt. % | Clear, | N |
| | | | | colorless | |
| CR-425-15-8 | 15 | wt. % | 0.02 wt. % | Clear, | N |
| | | | | colorless | |
| CR-425-13-A13 | 12.5 | wt. % | 0.25 wt. % | Slight haze | — |
| CR-425-13-A17 | 10 | wt. % | 0.50 wt. % | Hazy | — |
| CR-425-13-A11 | 10 | wt. % | 0.25 wt. % | Hazy, | — |

separates

Table 5 below also demonstrate the effect of salt addition. Examples using different essential oil (CR-423-13-B1) and different loadings of isopropanol (CR-425-13-A24 and CR-425-13-A23) are also included. As discussed above, addition of salt improves the performance of the surfactant, allowing for lower usage of the surfactant. The emulsion is freeze/thaw stable with a ratio of surfactant to essential oil as low as 4:1. Addition of solvent (e.g., isopropyl alcohol) also helps maintain the emulsion stability. The desired effect, such as the clear, colorless, and single-phased appearance is achieved with 15 wt. % or higher amount of isopropyl alcohol (IPA) with about 5 wt. % of essential oil.

TABLE 5

| | | Essential | | | Isopropyl | | |
|---|---|---|---|---|---|---|---|
| Formula | Surfactant | Oil | Surfactant:Oil | NaCl | Alcohol | Appearance | Phases |
| CR-425- | K cocoate | 2- | 5:1 | 0.25 wt. % | 20 wt. % | clear, | 1 |
| 13-A10 | | phenylethyl | | | | colorless | |
| | | propionate | | | | | |
| CR-425- | K cocoate | cedarwood | 5:1 | 0.25 wt. % | 20 wt. % | clear, | 1 |
| 13-B1 | | oil | | | | colorless | |
| CR-425- | K cocoate | 2- | 4:1 | 0.25 wt. % | 20 wt. % | clear, | 1 |
| 13-A16 | | phenylethyl | | | | colorless | |
| | | propionate | | | | | |
| CR-425- | K cocoate | 2- | 3:1 | 0.25 wt. % | 20 wt. % | clear, | 2 |
| 13-A12 | | phenylethyl | | | | colorless | |
| | | propionate | | | | | |
| CR-425- | K cocoate | 2- | 2.5:1 | 0.25 wt. % | 20 wt. % | hazy | 2 |
| 13-A13 | | phenylethyl | | | | | |
| | | propionate | | | | | |
| CR-425- | K cocoate | 2- | 2:1 | 0.25 wt. % | 20 wt. % | hazy | 2 |
| 13-A11 | | phenylethyl | | | | | |
| | | propionate | | | | | |
| CR-425- | K cocoate | 2- | 2:1 | 0.50 wt. % | 20 wt. % | hazy | 2 |
| 13-A17 | | phenylethyl | | | | | |
| | | propionate | | | | | |
| CR-425- | K cocoate | 2- | 4:1 | 0.10 wt. % | 20 wt. % | clear, | 1 |
| 13-A20 | | phenylethyl | | | | colorless | |
| | | propionate | | | | | |
| CR-425- | K cocoate | 2- | 4:1 | 0.05 wt. % | 20 wt. % | clear, | 1 |
| 13-A21 | | phenylethyl | | | | colorless | |
| | | propionate | | | | | |
| CR-425- | K cocoate | 2- | 4:1 | 0.02 wt. % | 20 wt. % | clear, | 1 |
| 13-A22 | | phenylethyl | | | | colorless | |
| | | propionate | | | | | |
| CR-425- | K cocoate | 2- | 4:1 | 0.02 wt. % | 15 wt. % | clear, | 2 |
| 13-A24 | | phenylethyl | | | | colorless | |
| | | propionate | | | | | |
| CR-425- | K cocoate | 2- | 4:1 | 0.02 wt. % | 10 wt. % | hazy | 2 |
| 13-A23 | | phenylethyl | | | | | |
| | | propionate | | | | | |

### Example 4

Examples 2-3 demonstrate that both solvent and salt contributed to creating a clear, colorless, stable formula with potassium cocoate and active ingredients. It was desired to further understand the formula design space and how the raw material loads could be optimized depending on the active ingredient load in the formula and type of active ingredient used. This would allow for flexibility in the formula to tune the active ingredient to the desired efficacy level and fragrance experience while still maintaining a cost-effective, stable formula. Therefore, the next step in developing the formula was to conduct a Design of Experiments (DOE) looking at high, medium, and low levels of the active ingredient, surfactant, and solvent. 2-phenylethyl propionate was chosen as the active ingredient for these trials because it has a pleasant odor and is not considered a VOC like some other active ingredient options.

Table 6 below shows the appearance and freeze/thaw stability results of different aqueous solutions with varying levels of active ingredient (2-PeP), potassium cocoate, and isopropanol. The formulas were either prepared in scintillation vials and shaken to mix or prepared in beakers and mixed via magnetic stirring. All formulas were visually observed for their appearance, and any formulas that appeared clear and colorless after batching were then subjected to one cycle of freezing and thawing to see if they remained clear, colorless and single phase. All formulas in Table 6 contained 0.02 wt. % sodium chloride and water was added to get to a 100% composition.

The results below show that at low (1 wt. %) active ingredient load, a stable formula can be achieved with a 3:1 surfactant to oil load and a high (20 wt. %) solvent level (CR-425-13-A32). If lower VOC levels are desired, the formula can be stable at a 5:1 surfactant: active ingredient (AI) ratio with only 8 wt. % solvent (CR-425-15-10). Having a low surfactant and low solvent load did not result in a stable formula (CR-425-15-6). At a high (5 wt. %) active ingredient load, a minimum ratio of 4:1 surfactant: AI was preferred along with at least 20 wt. % isopropanol (CR-425-13-A22). Reducing solvent or surfactant beyond these levels may result in an unstable formula at cold temperatures. At active ingredient loads between 1 wt. % and 5 wt. %, stable formulations are possible. CR-42515-3 showed a possible stable formulation at 5:1 surfactant to AI and 8 wt. % isopropanol. These results show that it would be possible to achieve an active ingredient loading of between about 1-5 wt. %.

TABLE 6
DOE of active ingredient, surfactant, and solvent load, all at 0.02 wt. % salt

| | | Potassium | | | | | F/T |
|---|---|---|---|---|---|---|---|
| Formula | 2-PeP | Cocoate | | IPA | | Appearance | Stable? |
| CR-425-15-5 | 1 wt. % | 5 | wt. % | 20 | wt. % | Clear, colorless | Y |
| CR-425-13-A32 | 1 wt. % | 3 | wt. % | 20 | wt. % | Clear, colorless | Y |
| CR-425-15-10 | 1 wt. % | 5 | wt. % | 8 | wt. % | Clear, colorless | Y |
| CR-425-15-6 | 1 wt. % | 3 | wt. % | 8 | wt. % | Milky, sediment | — |
| CR-425-15-3 | 3 wt. % | 15 | wt. % | 8 | wt. % | Clear, colorless | Y |
| CR-425-15-4 | 3 wt. % | 12 | wt. % | 8 | wt. % | Milky, sediment | — |
| CR-425-15-2 | 3 wt. % | 12 | wt. % | 14 | wt. % | Clear, colorless | N |
| CR-425-15-1 | 5 wt. % | 25 | wt. % | 20 | wt. % | Clear, colorless | Y |
| CR-425-13-A30 | 5 wt. % | 25 | wt. % | 15 | wt. % | Clear, colorless | N |
| CR-425-13-A27 | 5 wt. % | 25 | wt. % | 10 | wt. % | Clear, colorless | N |
| CR-425-15-7 | 5 wt. % | 25 | wt. % | 8 | wt. % | Clear, colorless | N |
| CR-425-13-A22 | 5 wt. % | 20 | wt. % | 20 | wt. % | Clear, colorless | Y |
| CR-425-15-11 | 5 wt. % | 20 | wt. % | 15 | wt. % | Clear, colorless | N |
| CR-425-13-A23 | 5 wt. % | 20 | wt. % | 10 | wt. % | Hazy | — |
| CR-425-15-8 | 5 wt. % | 15 | wt. % | 20 | wt. % | Clear, colorless | N |

### Example 5

So far, most of the testing completed was performed using 2-phenylethyl propionate as the active ingredient. This material was chosen for its compliance with EPA's minimum risk pesticide active ingredient regulation, its pleasant odor, and the fact that it is not a VOC. Other active ingredients from EPA's 25b list may behave somewhat differently in this formula system. To determine which active ingredients might be compatible with this formula system, several other active ingredients were tested in two different base formulas which contained 3 wt. % active ingredient, 15 wt. % potassium cocoate, 0.02 wt. % salt, either 8 wt. % or 20 wt. % isopropanol and the remainder water. The two formula variants are listed in Table 7 below.

TABLE 7
Base formulas for evaluating different active ingredients.

| | | |
|---|---|---|
| Ingredient | Formula 1 | Formula 2 |

| | | | | |
|---|---|---|---|---|
| Active Ingredient | 3 | wt. % | 3 | wt. % |
| Potassium Cocoate | 15 | wt. % | 15 | wt. % |
| Sodium Chloride | 0.02 | wt. % | 0.02 | wt. % |
| Isopropanol | 8 | wt. % | 20 | wt. % |

| | | |
|---|---|---|
| Water | q.s. | q.s |

The active ingredients evaluated are shown in Table 8 below. These formulas were mixed via shaking in scintillation vials and observed for their appearance. Most performed similarly to 2-phenylethyl propionate. Clove oil, geranium oil, and cedarwood oil all took longer to fully emulsify into solution at the low solvent level but were clear and colorless at high solvent level. Spearmint oil did not give the desired appearance in either formula.

TABLE 8
Formula appearance with different active ingredients.

| Active | Formula 1 | Formula 2 |
|---|---|---|
| Ingredient | Appearance | Appearance |
| 2-Phenylethyl | Clear | Clear |
| propionate | | |
| Clove oil | Hazy, clears over | Clear |
| | 24 hr | |
| Thyme oil | Clear | Clear |
| Cinnamon oil | Clear | Clear |
| Cornmint oil | Clear | Clear |
| Geranium oil | Hazy, clears over | Clear |
| | 24 hr | |
| Peppermint oil | Clear | Clear |
| Spearmint oil | Hazy, separates | Hazy, separates |
| Cedar wood oil | Hazy, clears over | Clear |
| | 24 hr | |
| Geraniol | Clear | Clear |
| Lemongrass oil | Clear | Clear |
| Rosemary oil | Clear | Clear |
| Eugenol | Clear | Clear |
| Wintergreen oil | Clear | Clear |

### Example 6

Table 9 summarizes the components of a water-based pest control composition containing potassium cocoate. Suitable essential oils for use in the composition include, but are not limited to, 2-phenylethyl propionate, cedarwood oil, cinnamon oil, citronella oil, clove oil, eugenol, garlic oil, geraniol, geranium oil, mint oil (e.g., spearmint oil, peppermint oil, cornmint oil, and mixtures thereof), lemongrass oil, rosemary oil, thyme oil, wintergreen oil, and mixtures thereof. Commercially available examples of potassium cocoate include, but are not limited to, Cola®Det KC-40 and Potassium Cocoate 40 from Sanitek.

TABLE 9

| Ingredient | Function | Wt. % |
|---|---|---|
| Purified Water | Water | 87.23 |
| Isopropanol | Solvent | 10.00 |
| Potassium Cocoate, 40 wt. % | Surfactant | 2.50 |
| Sodium Chloride | Salt | 0.02 |
| Essential Oil | Active Ingredient | 0.25 |

### Example 7

Table 10 summarizes an alternative water-based pest control composition containing higher content of potassium cocoate. Suitable essential oils for use in the composition include, but are not limited to, 2-phenylethyl propionate, cedarwood oil, cinnamon oil, citronella oil, clove oil, eugenol, garlic oil, geraniol, geranium oil, mint oil (e.g., spearmint oil, peppermint oil, cornmint oil, and mixtures thereof), lemongrass oil, rosemary oil, thyme oil, wintergreen oil, and mixtures thereof. Commercially available examples of potassium cocoate include, but are not limited to, Cola®Det KC-40 and Potassium Cocoate 40 from Sanitek.

TABLE 10

| CAS # | Ingredients | Function | Wt. % |
|---|---|---|---|
| 67-63-0 | Isopropanol | Solvent | 2-20 |
| Various | Any Essential Oil | Active Ingredient | 1-5 |
| Various | Soap (Sodium or Potassium | Surfactant | 4-20 |
| 61789-30-8 | Salts of Fatty Acids) | | |
| | OR | | |
| | Potassium Cocoate | | |
| 7647-14-5 | Sodium Chloride | Salt | 0.01-0.25 |
| 7732-18-5 | Purified Water | Water | q.s. |
| | | | 100 |

### Example 8

The efficacy of three trigger spray formulas containing potassium cocoate has been evaluated. Table 11 summarizes the components of the compositions. Untreated control was used in lieu of a control substance. Table 12 summarizes the identification of the test system.

TABLE 11
Components of the trigger spray formulas

| | 2-Phenylethyl | Soap | | | |
|---|---|---|---|---|---|
| Formula | Propionate | (K-Cocoate) | IPA | NaCl | Water |
| CR-425-22-1 | 0.25% | 1% | 5% | 0.02% | q.s. |
| CR-425-22-2 | 1% | 5% | 10% | 0.02% | q.s. |
| CR-425-22-3 | 5% | 25% | 20% | 0.02% | q.s |

TABLE 12
Identification of the test system

| | | | Stage/ | |
|---|---|---|---|---|
| | | | Sex/ | |
| Test System | Strain | Age | Caste | Resistance |
| German cockroach | Heal | 7 weeks old | Adult | Assumed non- |
| (Blattella germanica) | | from egg hatch | male | resistant strain |

Pre-treatment rearing condition: Insects were reared in SCJ facilities. Insects were provided with adequate food, water and harborage under controlled temperature and humidity conditions.

Control of bias: A population of only healthy vigorous insects were selected for this study by visual inspection, i.e., no twisted wings, missing appendages or aberrant behavior of an unhealthy insect.

Justification for selection of test system: German cockroaches are an important pest insect throughout the United States and globally. They are readily and reliably reared in a laboratory setting, which allows testing to be performed under controlled and reproducible conditions.

Abstract: Three trigger spray formulas were tested against German cockroach pests. Three trigger pulls of the test substance from a spray distance of 12 inches were applied directly on the test system, the test system was given the opportunity to leave the treated surface after 20 seconds. The test system was transferred to a clean container to record mortality. Knockdown counts were made at predetermined intervals as designated in this report. Test systems were held for 24-hours post-treatment to record mortality.

### Materials:

A. Test Substance:
   1. 3 trigger spray formulas.
   2. Description: Trigger spray.
B. A calibrated balance which weighs to 0.01 g. The appropriate SOP for the balance will be followed. The balance identification number will be documented in the raw data.
C. Test Room, apparatus and materials:
   1. Test room conditions:
      a. Temperature, 83° F. (28° C.)
      b. 44-53% Relative Humidity.
      c. Artificial lighting. Photoperiod not relevant for this testing.
   2. Large Arena Spray Platform (102 cm×76 cm×40 cm).
      a. Large Arena Lucite ring to allow cockroaches to move freely following the spray treatment (60 cm dia.×8 cm height).
      b. Short confinement Lucite ring to keep German cockroaches confined during spray treatment 12.5 cm dia.×5 cm height.
      c. The confinement ring is positioned on top of a small piece of vinyl (15 cm×15 cm). A clean ring and new piece of vinyl will be provided for every replicate.
      d. One roll of 91.5 cm wide brown Kraft paper attached to the back of the Spray Platform. The paper is pulled onto the Spray Platform floor and changed between evely test replicate.
      e. Adjustable fume hood positioned over spray platform. Fume hood opening 31 cm×24 cm.
   3. Holding containers-plastic cups (8.57 cm diameter×8 cm height) model 115A Pioneer Plastics, Dixon, KY.
   4. Screen covers for plastic cups.
   5. Grease (petroleum jelly/mineral oil mixture) to coat sides of all Lucite rings and containers used for holding cockroaches.
   6. CO₂ source for temporarily immobilizing the cockroaches.
   7. Cockroach knockdown tray-Plexiglas tray with a false floor 2.5 cm above real floor. False floor patterned with 0.3 cm holes that allowed CO₂ to enter box from under the false floor and anesthetize the cockroaches.
   8. Stopwatch/timer.
   9. Data sheets.
   10. Permanent pen.
   11. Hygrothermograph or equivalent instrument used to document temperature and relative humidity.
   12. Ruler for measuring spray distance.
   13. Soft forceps for transferring cockroaches to holding cup.
   14. Ware washing machine.
   15. Dental wicks.
   16. Guinee pig chow.

### Method:

### A. Test Design

I. Three replicates with each test substance were conducted with knockdown counts at 30 seconds, 2 minutes, and 5 minutes. Insects were freed from confinement ring by lifting it away at 20 seconds post-treatment. Insects were transferred to holding container 5 minutes post-treatment. Mortality counts were taken at 24±2 hours, post treatment. Additionally, three untreated control replicates were set-up and 24±2-hours mortality counts taken. The Study Director or Investigator called “the end of test” after the 24-hour mortality count as it was apparent that surviving insects would not be further impacted by the test substance.
2. Targeted spray distance was approximately 12″ (30 cm).
3. The test substance was sprayed directly at test insects with three trigger pulls.
4. The test substance was weighed before and after spraying to determine the actual dosage.
5. From this actual dose an active ingredient application rate was calculated and reported.

### B. Test System Preparation

1. All testing was conducted on site.
2. Cockroach set-up took place the afternoon of the day before test substance application:
   a. Holding containers were lightly greased to keep cockroaches from escaping.
   b. Transported the cockroach rearing jars to the laboratory where set-up took place.
   c. Connected CO₂ source to the knockdown tray. Turned on CO₂ valve and let CO₂ accumulate in the knockdown tray for approximately 10-15 seconds.
   d. Removed rearing harborage from the rearing jar and placed it in the center of knockdown tray. As insects began to fall into the tray, the CO₂ flow was reduced. Flow was minimized to a level sufficient to only to keep the insects anesthetized.
   e. Returned harborage to rearing jar.
   f. Sorted cockroaches by sex and placed ten adult males into each holding cup. A voided selecting insects with any deformities such as missing legs or wings.

### C. Test Procedure

1. Prepared all Lucite rings for testing by lightly greasing side walls.
2. Set-up Large Arena Platform for testing by pulling clean Kraft paper over floor of platform. Placed large arena Lucite ring on platform. In the middle of the large arena, placed appropriate containment Lucite ring over a vinyl panel. Measured approximate spray distance between test substance spray actuator and the insects. Targeted spray distance was approximately 12 inches (30 cm).
3. The test substance was weighed before and after spraying, and recorded to determine the actual dosage.
4. Before starting the test, checked vigor and health of insects to ensure insects survived the set-up procedure, did not use any insect containers that contained dead or deformed insects.
5. Immediately prior to the test substance application, transferred cockroaches from holding container to Lucite confinement ring by inverting holding cup with cockroaches into the containment ring and tapping bottom of cup causing cockroaches to fall into the containment ring.
6. Applied the test substance. At the same time as test substance application, started timer to begin timing for release from ring, knockdown and mortality counts.
7. Twenty seconds after test substance application, lifted containment ring allowing cockroaches to run freely in the large arena.
8. Observation/Knockdown Counts
   Cockroach knockdown is defined as cockroaches experiencing some aberrant behavior such as: on their back or side, unable to maintain a normal posture when righted and/or leg twitching or similar involuntary movements of a moribund insect.
9. Counted and documented the number of cockroaches knockdown at the thirty second, 2 minute and, 5 minute observation intervals post application.
10. After 5 minutes, transferred cockroaches into clean greased holding containers.
11. Provided all test subjects with water-soaked dental wick.
12. Untreated control replicates were held for mortality counts.
13. At completion of testing, cleaned all Lucite rings using ware washing machine.
14. Mortality counts:
   Observation counts will consist of three classifications:
      Alive Cockroaches. Alive cockroaches are defined as insects that visually appears to be in a normal and viable state of health and respond with movement when prodded.
      Knockdown Cockroaches: knockdown for cockroaches defined as cockroaches experiencing some aberrant behavior such as: on their back or side, unable to maintain a normal posture when righted and/or leg twitching or similar involuntary movements of a moribund insect.
      Dead Cockroaches. Dead Cockroaches are defined as cockroaches that do not respond with movement of any kind when prodded.
   We counted and documented the number of alive, KD and dead cockroaches at 24±2 hours each for each of the test substances and untreated controls. The Study Director chooses to call “the end of test” after the 24 hour mortality observation as it was apparent the surviving insects would no longer be impacted by the test substance. Insect mortality is defined as the number of dead, but not knocked down, insects (insects that do not move even after prodding or are incapable of coordinated movement, or unable to right themselves even after prodding).
15. Following the final mortality count, disposed of test insects in the garbage disposal and washed holding cups in ware washing machine.

Analysis of the Data: Percent knockdown and percent mortality were determined for the various observation times for the test system treated with the test substance. Similarly, percent mortality was determined for the untreated controls. Calculated the means for percent knockdown and mortality and the standard error of mean (SEM) for each mean value via Microsoft Excel. Active ingredient application rate values were also calculated.

Table 13 summarizes each formula's performance against the test system. All three formulas achieved ≥87% mortality by 24 hours post-treatment against German cockroaches. Table 14 summarizes active ingredient application rates for each formula.

TABLE 13
Mean percent knockdown and mean percent
mortality results for German cockroach.

| | Mean | | | | | | | Mean | |
|---|---|---|---|---|---|---|---|---|---|
| | amount | Mean % Knockdown | | | | | | Mortality | |
| Test | dispensed | 30 sec | | 2 min | | 5 min | | 24 hrs | |
| Substance | wt (g) | % kd | SEM | % kd | SEM | % kd | SEM | % dead | SEM |
| CR-425-22-1 | 2.84 | 63 | 0 | 80 | 0 | 83 | 0 | 87 | 0 |
| CR-425-22-2 | 2.89 | 43 | 0 | 77 | 0 | 87 | 0 | 93 | 0 |
| CR-425-22-3 | 2.87 | 93 | 0 | 97 | 0 | 97 | 0 | 97 | 0 |
| untreated | na | na | na | na | na | na | na | 0 | 0 |
| Control | | | | | | | | | |

TABLE 14
Active ingredient application rate for each formula.
Active Ingredient Application Rage - CR-425-22-1

| Test system | | | | Isopropyl |
|---|---|---|---|---|
| German | Active Ingredient | 2-Pep | Soap | Alcohol |
| Cockroach | % per label | 0.25 | 1 | 5 |
| Rep | amount dispensed (g) | (mg) | (mg) | (mg) |
| 1 | 2.83 | 7.08 | 28.30 | 141.50 |
| 2 | 2.88 | 7.20 | 28.80 | 144.00 |
| 3 | 2.81 | 7.03 | 28.10 | 140.50 |
| mean | 2.84 | 7.10 | 28.40 | 142.00 |
| SEM | 0.02 | 0.05 | 0.21 | 1.04 |

Active Ingredient Application Rage - CR-425-22-2

| Test system | | | | Isopropyl |
|---|---|---|---|---|
| German | Active Ingredient | 2-Pep | Soap | Alcohol |
| Cockroach | % per label | 1 | 5 | 10 |
| Rep | amount dispensed (g) | (mg) | (mg) | (mg) |
| 1 | 2.84 | 28.40 | 142.00 | 284.00 |
| 2 | 2.91 | 29.10 | 145.50 | 291.00 |
| 3 | 2.92 | 29.20 | 146.00 | 292.00 |
| mean | 2.89 | 28.90 | 144.50 | 289.00 |
| SEM | 0.03 | 0.25 | 1.26 | 2.52 |

Active Ingredient Application Rage - CR-425-22-3

| Test system | | | | Isopropyl |
|---|---|---|---|---|
| German | Active Ingredient | 2-Pep | Soap | Alcohol |
| Cockroach | % per label | 5 | 25 | 20 |
| Rep | amount dispensed (g) | (mg) | (mg) | (mg) |
| 1 | 2.87 | 143.50 | 717.50 | 574.00 |
| 2 | 2.88 | 144.00 | 720.00 | 576.00 |
| 3 | 2.87 | 143.50 | 717.50 | 574.00 |
| mean | 2.87 | 143.67 | 718.33 | 574.67 |
| SEM | 0.00 | 0.17 | 0.83 | 0.67 |

The results suggest that all formulas were effective at killing German cockroaches.

### Example 9

Table 15 summarizes the components of a water-based pest control composition containing sodium ricinoleate. Suitable essential oils for use in the composition include, but are not limited to, 2-phenylethyl propionate, cedarwood oil, cinnamon oil, citronella oil, clove oil, eugenol, garlic oil, geraniol, geranium oil, mint oil (e.g., spearmint oil, peppermint, cornmint oil, and mixtures thereof), lemongrass oil, rosemary oil, thyme oil, wintergreen oil, and mixtures thereof. Commercially available examples of sodium ricinoleate include Innoleate RA-Na.

TABLE 15

| CAS # | Ingredients | Function | Wt. % |
|---|---|---|---|
| 67-63-0 | Isopropanol | Solvent | 1-20 |
| Various | Any Essential Oil | Active Ingredient | 0.1-5 |
| 5323-95-5 | Sodium Ricinoleate | Surfactant | 0.5-50 |
| 7647-14-5 | Sodium Chloride | Salt | 0.02-0.1 |
| 7732-18-5 | Purified Water | Water | q.s. |
| | | | 100 |

### Example 10

The effect of changing the relative amount of the surfactant and the essential oil was studied. As shown in Table 16, addition of salt improves the performance of the surfactant, allowing for lower usage of the surfactant. All the examples in Table 16 contains about 1 wt. % of essential oil.

TABLE 16

| | | | | Isopropyl | |
|---|---|---|---|---|---|
| Surfactant | Essential Oil | Surfactant:Oil | NaCl | Alcohol | Appearance |
| Sodium | 2-phenylethyl | 10:1 | | 10 wt. % | Clear, colorless, |
| Ricinoleate | propionate | | | | some fallout |
| | | | | | with F/T; shakes |
| | | | | | back in |
| Sodium | 2-phenylethyl | 5:1 | | 10 wt. % | Clear, colorless, |
| Ricinoleate | propionate | | | | some fallout |
| | | | | | with F/T; shakes |
| | | | | | back in |
| Sodium | 2-phenylethyl | 3:1 | | 10 wt. % | Slight haze, |
| Ricinoleate | propionate | | | | minimal |
| | | | | | sediment |
| Sodium | 2-phenylethyl | 3:1 | 0.02 wt. % | 10 wt. % | Clear, colorless, |
| Ricinoleate | propionate | | | | some fallout |
| | | | | | with F/T; shakes |
| | | | | | back in |
| Sodium | 2-phenylethyl | 1:1 | 0.02 wt. % | 10 wt. % | Milky white |
| Ricinoleate | propionate | | | | |
| Sodium | 2-phenylethyl | 2:1 | 0.02 wt. % | 10 wt. % | Milky white |
| Ricinoleate | propionate | | | | |

In summary, a water-based formula that is compliant with EPA's minimum-risk pesticide regulation, does not contain any palm-derived materials, is modifiable to meet the VOC requirements depending on the type of product use desired, and can be used with a variety of active ingredients to achieve different fragrance profiles or efficacy targets was created. A soap surfactant (e.g., potassium cocoate or sodium ricinoleate), a solvent (e.g., isopropanol), and a salt (e.g., sodium chloride) were included in the formula to achieve optimal appearance, stability, and cost profile. The exact amounts depend on the amount of active ingredient used and the desired VOC limits based on the product type.

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the disclosure and to teach the best mode of carrying out same. The exclusive rights to all modifications which come within the scope of the appended claims are reserved.

1. A pest control composition, the composition comprising:
from about 0.25 wt. % to about 10 wt. % of an active ingredient comprising one or more essential oils;
from about 10 wt. % to about 30 wt. % of a surfactant comprising potassium cocoate;
from about 5 wt. % to about 30 wt. % of a solvent;
from about 0.005 wt. % to about 0.1 wt. % of a salt; and
from about 40 wt. % to about 70 wt. % of water;
wherein all weight percentages are percent by weight of the total composition;
wherein the composition is single-phased between about 0° C. to about 54° C.

2. The pest control composition of claim 1, wherein the essential oil is selected from 2-phenylethyl propionate, cedarwood oil, geraniol, cinnamon oil, citronella oil, clove oil, eugenol, garlic oil, geranium oil, spearmint oil, peppermint oil, cornmint oil, lemongrass oil, rosemary oil, thyme oil, wintergreen oil, and mixtures thereof.

3. The pest control composition of claim 1, wherein the essential oil is 2-phenylethyl propionate.

4. The pest control composition of claim 1, wherein the solvent comprises isopropyl alcohol.

5. The pest control composition of claim 1, wherein the salt comprises sodium chloride.

6. The pest control composition of claim 1, wherein the total amount of the surfactant and the total amount of the essential oil have a weight ratio of at least 3:1.

7. The pest control composition of claim 1, wherein the solvent is at least 15 wt. % of the total composition.

8. The pest control composition of claim 1, wherein the composition is clear and colorless between about 0° C. to about 54° C.

9. A pest control composition, the composition comprising:
from about 1 wt. % to about 10 wt. % of an active ingredient comprising one or more essential oils;
from about 10 wt. % to about 30 wt. % of a surfactant comprising a mixture of potassium salts of C6-C20 fatty acids;
from about 5 wt. % to about 30 wt. % of a solvent;
from about 0.005 wt. % to about 0.1 wt. % of a salt; and
from about 40 wt. % to about 70 wt. % of water;
wherein all weight percentages are percent by weight of the total composition;
wherein the composition is single-phased between about 0° C. to about 54° C.

10. The pest control composition of claim 9, wherein the C6-C20 fatty acids comprises caproic acid, caprylic acid, capric acid, lauric acid, myristic acid, palmitic acid, stearic acid, arachidic acid, oleic acid, linoleic acid, or any combinations thereof.

11. The pest control composition of claim 9, wherein at least 40 wt. % of the C6-C20 fatty acids is a saturated C12 fatty acid.

12. The pest control composition of claim 9, wherein the essential oil is selected from 2-phenylethyl propionate, cedarwood oil, geraniol, cinnamon oil, citronella oil, clove oil, eugenol, garlic oil, geranium oil, spearmint oil, peppermint oil, cornmint oil, lemongrass oil, rosemary oil, thyme oil, wintergreen oil, and mixtures thereof.

13. The pest control composition of claim 9, wherein the essential oil is 2-phenylethyl propionate.

14. The pest control composition of claim 9, wherein the solvent comprises isopropyl alcohol.

15. The pest control composition of claim 9, wherein the salt comprises sodium chloride.

16. The pest control composition of claim 9, wherein the total amount of the surfactant and the total amount of the essential oil have a weight ratio of at least 3:1.

17. The pest control composition of claim 9, wherein the composition is clear and colorless between about 0° C. to about 54° C.

18. A pest control composition, the composition comprising:
from about 0.25 wt. % to about 10 wt. % of an essential oil selected from 2-phenylethyl propionate, cedarwood oil, geraniol, cinnamon oil, citronella oil, clove oil, eugenol, garlic oil, geranium oil, spearmint oil, peppermint oil, cornmint oil, lemongrass oil, rosemary oil, thyme oil, wintergreen oil, and mixtures thereof;
from about 1 wt. % to about 30 wt. % of potassium cocoate;
from about 5 wt. % to about 30 wt. % of isopropyl alcohol;
from about 0.005 wt. % to about 0.1 wt. % of sodium chloride; and
from about 40 wt. % to about 95 wt. % of water;
wherein all weight percentages are percent by weight of the total composition.

19. The pest control composition of claim 18, wherein the total amount of potassium cocoate and the total amount of the essential oil have a weight ratio of at least 3:1.

20. The pest control composition of claim 18, wherein the composition is single-phased, clear, and colorless between about 0° C. to about 54° C.

21-41. (canceled)
